(19) United States
(12) Patent Application Publication
(10) Pub. No.: US 2024/0114305 A1
(43) Pub. Date: Apr. 4, 2024

(54) Playback Systems with Dynamic Forward Error Correction

(71) Applicant: Sonos, Inc., Santa Barbara, CA (US)

(72) Inventor: Steven Beckhardt, Santa Barbara, CA (US)

(21) Appl. No.: 18/476,193

(22) Filed: Sep. 27, 2023

Related U.S. Application Data
(60) Provisional application No. 63/377,967, filed on Sep. 30, 2022.
(60) Provisional application No. 63/377,899, filed on Sep. 30, 2022.
(60) Provisional application No. 63/377,948, filed on Sep. 30, 2022.
(60) Provisional application No. 63/377,978, filed on Sep. 30, 2022.
(60) Provisional application No. 63/377,979, filed on Sep. 30, 2022.

(51) Int. Cl. H04R 29/00; G11B 27/36; H04L 1/00

(52) U.S. Cl. CPC H04R 29/001; G11B 27/36; H04L 1/0047

(57) ABSTRACT

Disclosed examples include playback systems comprising several playback devices that are configured for selectively using Forward Error Correction (FEC) to distribute audio content to playback devices within the playback group. Some examples include a first playback transmitting FEC data based on data for use by at least a second playback device after determining that the second playback device has failed to successfully receive more than a threshold amount of the data previously transmitted by the first playback device.

### CROSS REFERENCE TO RELATED APPLICATIONS

This application claims priority to (i) U.S. Provisional App. 63/377,967, titled “Playback Systems with Dynamic Forward Error Correction,” referred to as Docket No. 22-0401p (0403973) filed on Sep. 30, 2022, and currently pending; (ii) U.S. Provisional App. 63/377,899, titled “Multichannel Content Distribution,” referred to as Docket No. 22-0207p (0400042), filed on Sep. 30, 2022; (iii) U.S. Provisional App. 63/377,948, titled “Playback System Architecture,” referred to as Docket No. 21-0703p (0401247), filed on Sep. 30, 2022; (iv) U.S. Provisional App. 63/377,978, titled “Broker/Subscriber Model for Information Sharing and Management Among Connected Devices,” referred to as Docket No. 22-0606Ap (0404192), filed on Sep. 30, 2022; and (iv) U.S. Provisional App. 63/377,979, titled “Multiple Broker Deployment for Information Sharing and Management Among Connected Devices,” referred to as Docket No. 22-0606Bp (0404193), filed on Sep. 30, 2022. The entire contents of 63/377,967; 63/377,899; 63/377,948; 63/377,978; and 63/377,979 are incorporated herein by reference.

Aspects of the features and functions disclosed and described in the above-identified applications can be used in combination with the examples disclosed and described herein and with each other in some instances to improve the functionality and performance of playback systems including but not limited to playback systems having large numbers of playback devices.

### FIELD OF THE DISCLOSURE

The present disclosure is related to consumer goods and, more particularly, to methods, systems, products, features, services, and other elements directed to media playback systems, media playback devices, and aspects thereof.

### BACKGROUND

Options for accessing and listening to digital audio in an out-loud setting were limited until in 2002, when SONOS, Inc. began development of a new type of playback system. Sonos then filed one of its first patent applications in 2003, titled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), individuals can play most any music they like in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1-I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D

FIG. 3F shows a schematic diagram of an example voice input.

FIGS. 4A-4D show schematic diagrams of a control device in various stages of operation in accordance with aspects of the disclosed technology.

FIG. 5 shows front view of a control device.

FIG. 6 shows a message flow diagram of a media playback system.

FIG. 7 shows a media playback system according to some example configurations.

FIG. 8 shows a method performed by an audio sourcing device according to some example configurations.

FIG. 9 shows a method performed by a playback device configured to use FEC data to correct errors in audio content and/or playback timing received from an audio sourcing device according to some example configurations.

The drawings are for the purpose of illustrating example configurations, but those of ordinary skill in the art will understand that the technology disclosed herein is not limited to the arrangements and/or instrumentality shown in the drawings.

### DETAILED DESCRIPTION

### I. Overview

Some existing intelligent playback devices, such as playback devices offered for sale by Sonos, Inc., have tremendous flexibility in terms of configuration options and ability to play many different types of audio content, thereby enabling many different playback system configurations for many different types of listening environments.

One desirable feature of some existing intelligent playback devices is the ability of playback groups including several playback devices to consistently and reliably play audio content together in a groupwise manner with each other, including playing content in synchrony with each other. In some example implementations, technical features that help enable playback groups formed from such playback devices to consistently and reliably play audio content together in a groupwise manner relate to the manner in which an audio sourcing device (which may be a group coordinator) in a playback group unicasts a data stream comprising audio content and playback timing for the audio content to each group member (playback device) separately in the playback group. By unicasting a data stream to each group member individually, the audio sourcing device enables each group member to consistently and reliably receive the data stream in part because, with unicast transmissions, each group member is able to request retransmissions of missing or corrupted packets within the data stream from the audio sourcing device providing the audio content and playback timing.

Although unicasting a separate stream to each group member enables reliable receipt of all the packets in the data stream by each group member, unicasting a separate stream to each group member can become technically challenging for playback groups that include a large number of group members because the volume of data transmitted from the audio sourcing device to each of the group members grows as the total number of group members in the playback group increases. For playback groups having several tens of playback devices, or for playback systems comprising several large playback groups, the total number of the playback devices within the playback system may approach or even exceed 100s of playback devices. In such playback system implementations especially involving large numbers of playback devices, but also in any playback system in general, unicasting a separate stream from the audio sourcing device to each playback device operating as a group member in the playback system consumes a large amount of network bandwidth and also creates a heavy processing load on the audio sourcing device. Depending on the underlying network infrastructure and the total number of playback devices in the playback system, some networks may lack sufficient bandwidth to support unicasting a separate stream from the audio sourcing device to every individual playback device in the playback system. Similarly, some audio sourcing devices may lack sufficient processing and networking capabilities to support unicasting a separate stream from the audio sourcing device to every individual playback device in the playback system. In any event, it may be generally preferable to reduce processing and/or network bandwidth requirements throughout the system regardless of how many playback devices may be in the playback system.

To help ameliorate some of the technical problems that may arise with playback systems having large numbers of playback devices, example configurations disclosed and described herein implement different combinations of unicasting, multicasting, and/or broadcasting audio content and playback timing in combination with Forward Error Correction (FEC) data in different network scenarios.

For example, some example configurations herein introduce combinations of features to improve playback system performance, including but not necessarily limited to one or more (or all) of: (i) audio sourcing devices multicasting audio content and playback timing to multicast groups to which individual playback devices may join/subscribe to receive the audio content and playback timing, thereby reducing the processing load on the audio sourcing device and network capacity required to unicast audio content and playback timing to playback devices individually; (ii) audio sourcing devices generating Forward Error Correction (FEC) data based on the audio content and playback timing that individual playback devices can use to correct errors in the audio content and/or playback timing received from the audio sourcing device, particularly in configurations where the audio sourcing device multicasts the audio content and playback timing to playback devices such that retransmission requests for the multicast transmissions might be difficult/impractical (or perhaps impossible) to process and implement; (iii) audio sourcing devices selectively streaming FEC data to individual playback devices on a playback device by playback device basis, e.g., selectively streaming FEC data only to playback devices that need the FEC data to correct errors in the audio content and/or playback timing received from the audio sourcing device; (iv) audio sourcing devices that implement multiple FEC algorithms, e.g., a first FEC algorithm and a second (comparatively stronger) FEC algorithm, and where the audio sourcing device selectively streams first FEC data generated according to the first FEC algorithm or second FEC data generated according to the second (stronger) FEC algorithm to individual playback devices, perhaps on a playback device by playback device basis, based on quantity (e.g., error rate) and/or severity of errors being detected by individual playback devices; (v) audio sourcing devices that implement multiple FEC algorithms, e.g., a first FEC algorithm and a second (stronger) FEC algorithm, where an individual playback device selectively chooses to receive and use either first FEC data generated according to the first FEC algorithm or second FEC data generated according to the second, stronger FEC algorithm based on quantity (e.g., error rate) and/or severity of errors being detected by the individual playback device; and/or (vi) audio sourcing devices that stream FEC data to playback devices via different channels, different networks, and/or different transmission protocols than the channels, networks, and/or protocols via which the audio sourcing device streams audio content and playback timing to playback devices, thereby reducing the likelihood that the network problems causing errors in the audio content and/or playback timing will also affect the stream of FEC data that the playback devices will use to correct the errors in the audio content and/or playback timing.

The above-described example configurations as well as additional and alternative example configurations and related aspects thereof are described in more detail herein. While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

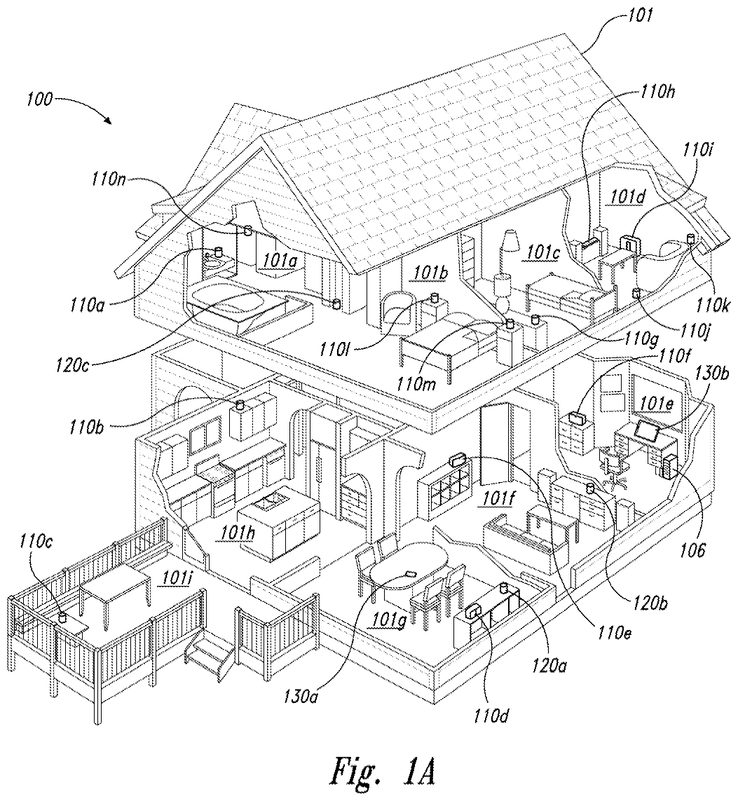

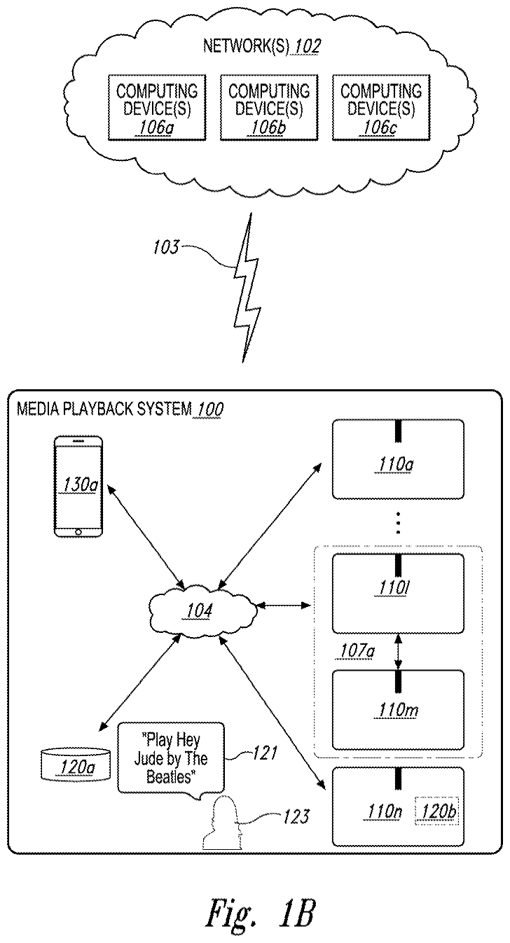

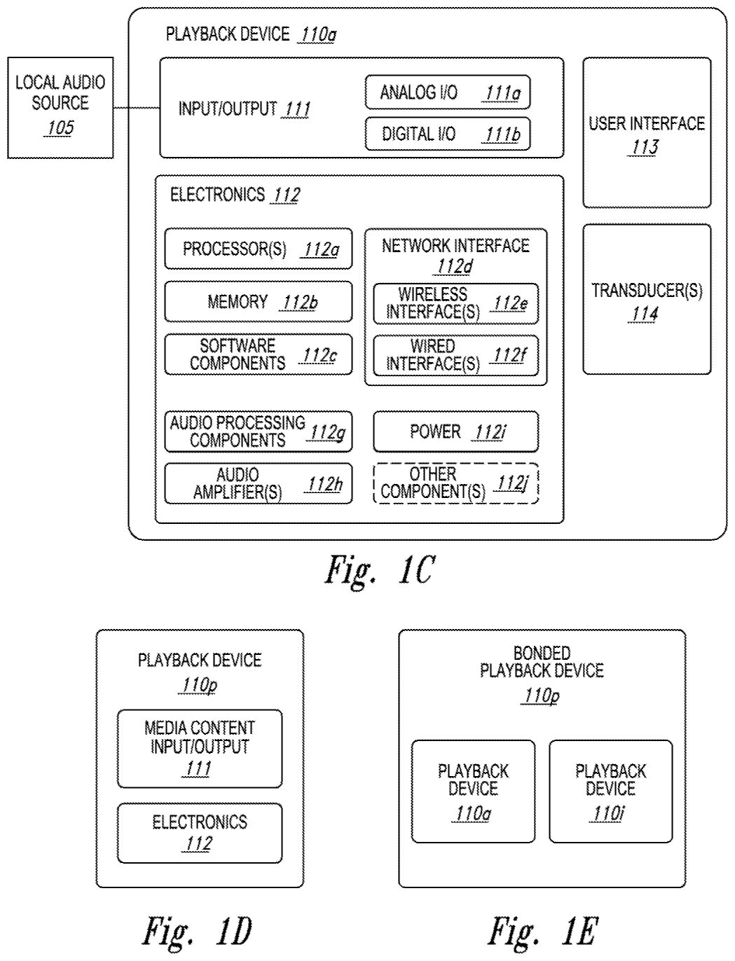

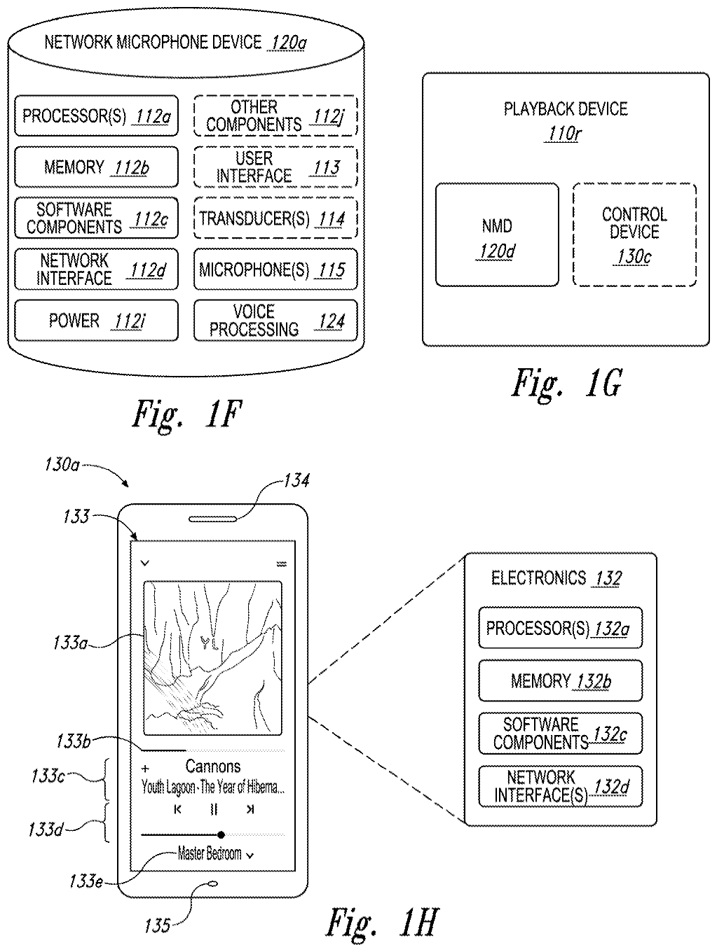

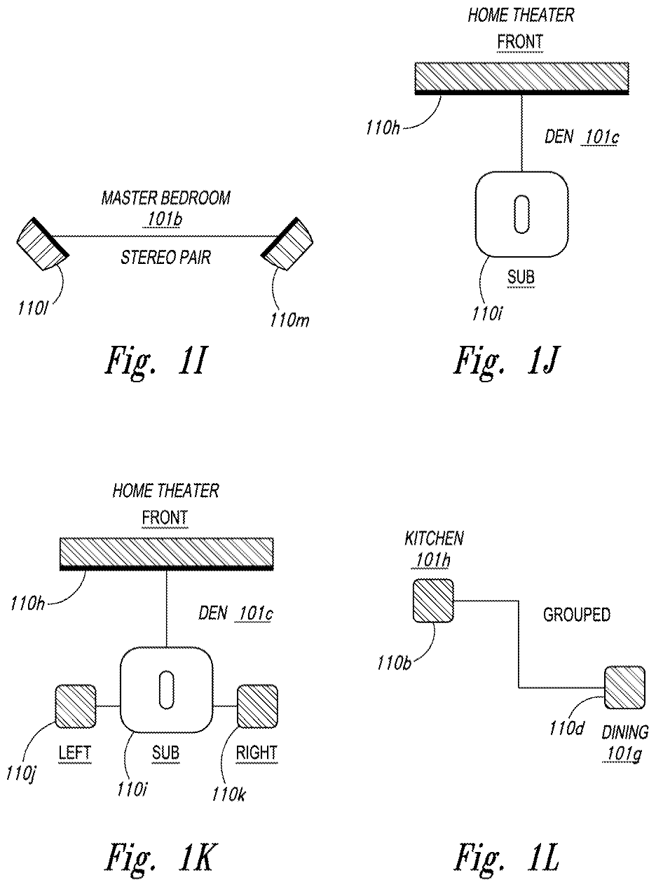

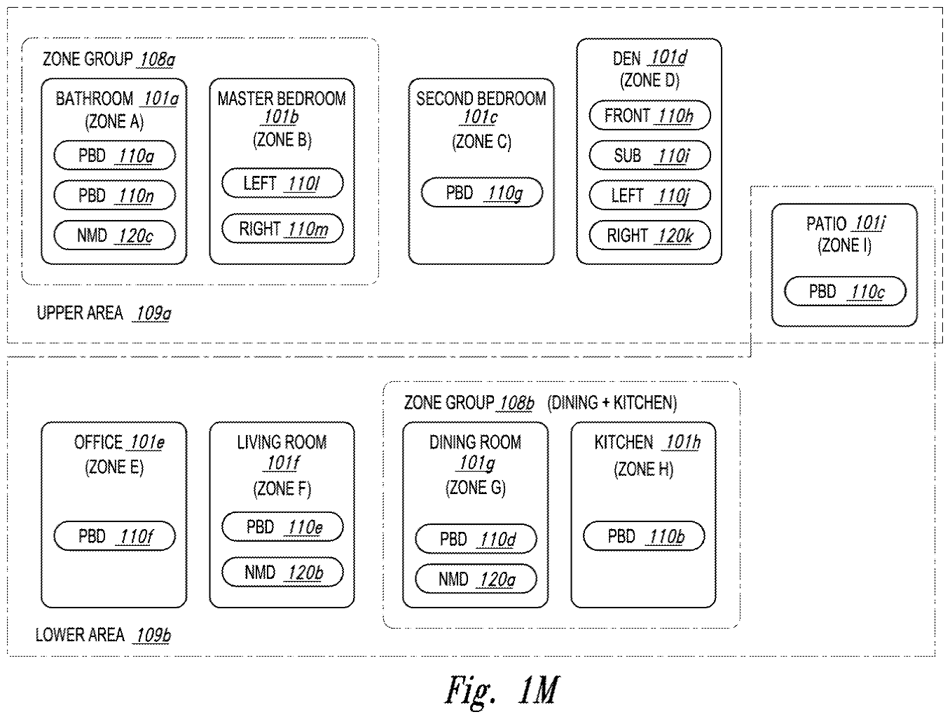

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular example configurations of the disclosed technology. Accordingly, other example configurations can have other details, dimensions, angles and features without departing from the spirit or scope of the disclosure. In addition, those of ordinary skill in the art will appreciate that further example configurations of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some example configurations, a playback device includes one or more transducers or speakers powered by one or more amplifiers. In other example configurations, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some example configurations, an NMD is a stand-alone device configured primarily for audio detection. In other example configurations, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain example configurations, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some example configurations, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various example configurations of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain example configurations and examples are described below in the context of a home environment, the technologies described herein may be implemented in other types of environments. In some example configurations, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communications links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some example configurations, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some example configurations, one or more of the computing devices 106 comprise modules of a single computer or server. In certain example configurations, one or more of the computing devices 106 comprise one or more modules, computers, and/or servers. Moreover, while the cloud network 102 is described above in the context of a single cloud network, in some example configurations the cloud network 102 comprises a plurality of cloud networks comprising communicatively coupled computing devices. Furthermore, while the cloud network 102 is shown in FIG. 1B as having three of the computing devices 106, in some example configurations, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some example configurations, the network 104 comprises a dedicated communication network that the media playback system 100 uses to transmit messages between individual devices and/or to transmit media content to and from media content sources (e.g., one or more of the computing devices 106). In certain example configurations, the network 104 is configured to be accessible only to devices in the media playback system 100, thereby reducing interference and competition with other household devices. In other example configurations, however, the network 104 comprises an existing household communication network (e.g., a household WiFi network). In some example configurations, the links 103 and the network 104 comprise one or more of the same networks. In some aspects, for example, the links 103 and the network 104 comprise a telecommunication network (e.g., an LTE network, a 5G network). Moreover, in some example configurations, the media playback system 100 is implemented without the network 104, and devices comprising the media playback system 100 can communicate with each other, for example, via one or more direct connections, PANs, telecommunication networks, and/or other suitable communications links.

In some example configurations, audio content sources may be regularly added or removed from the media playback system 100. In some example configurations, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some example configurations, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain example configurations, for example, the group 107a comprises a bonded zone in which the playback devices 110l and 110m comprise left audio and right audio channels, respectively, of multi-channel audio content, thereby producing or enhancing a stereo effect of the audio content. In some example configurations, the group 107a includes additional playback devices 110. In other example configurations, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some example configurations, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communications links configured to carry analog signals) and/or a digital I/O 111b (e.g., one or more wires, cables, or other suitable communications links configured to carry digital signals). In some example configurations, the analog I/O 111a is an audio line-in input connection comprising, for example, an auto-detecting 3.5 mm audio line-in connection. In some example configurations, the digital I/O 111b comprises a Sony/Philips Digital Interface Format (S/PDIF) communication interface and/or cable and/or a Toshiba Link (TOSLINK) cable. In some example configurations, the digital I/O 111b comprises an High-Definition Multimedia Interface (HDMI) interface and/or cable. In some example configurations, the digital I/O 111b includes one or more wireless communications links comprising, for example, a radio frequency (RF), infrared, WiFi, Bluetooth, or another suitable communication protocol. In certain example configurations, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communications link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain example configurations, one or more of the playback devices 110, NMDs 120, and/or control devices 130 comprise the local audio source 105. In other example configurations, however, the media playback system omits the local audio source 105 altogether. In some example configurations, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some example configurations, the playback device 110a optionally includes one or more microphones 115 (e.g., a single microphone, a plurality of microphones, a microphone array) (hereinafter referred to as “the microphones 115”). In certain example configurations, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some example configurations, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some example configurations, the operations further include causing the playback device 110a to send audio information to another one of the playback devices 110a and/or another device (e.g., one of the NMDs 120). Certain example configurations include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some example configurations, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some example configurations, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain example configurations, the network interface 112d includes the wired interface 112f and excludes the wireless interface 112e. In some example configurations, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some example configurations, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain example configurations, one or more of the audio processing components 112g can comprise one or more subcomponents of the processors 112a. In some example configurations, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some example configurations, for example, the amplifiers 112h include one or more switching or class-D power amplifiers. In other example configurations, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain example configurations, the amplifiers 112h comprise a suitable combination of two or more of the foregoing types of power amplifiers. Moreover, in some example configurations, individual ones of the amplifiers 112h correspond to individual ones of the transducers 114. In other example configurations, however, the electronics 112 includes a single one of the amplifiers 112h configured to output amplified audio signals to a plurality of the transducers 114. In some other example configurations, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some example configurations, the transducers 114 can comprise a single transducer. In other example configurations, however, the transducers 114 comprise a plurality of audio transducers. In some example configurations, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain example configurations, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example configurations disclosed herein. Additionally, one of ordinary skilled in the art will appreciate that a playback device is not limited to the examples described herein or to SONOS product offerings. In some example configurations, for example, one or more playback devices 110 comprises wired or wireless headphones (e.g., over-the-ear headphones, on-ear headphones, in-ear earphones). In other example configurations, one or more of the playback devices 110 comprise a docking station and/or an interface configured to interact with a docking station for personal mobile media playback devices. In certain example configurations, a playback device may be integral to another device or component such as a television, a lighting fixture, or some other device for indoor or outdoor use. In some example configurations, a playback device omits a user interface and/or one or more transducers. For example, FIG. 1D is a block diagram of a playback device 110p comprising the input/output 111 and electronics 112 without the user interface 113 or transducers 114.

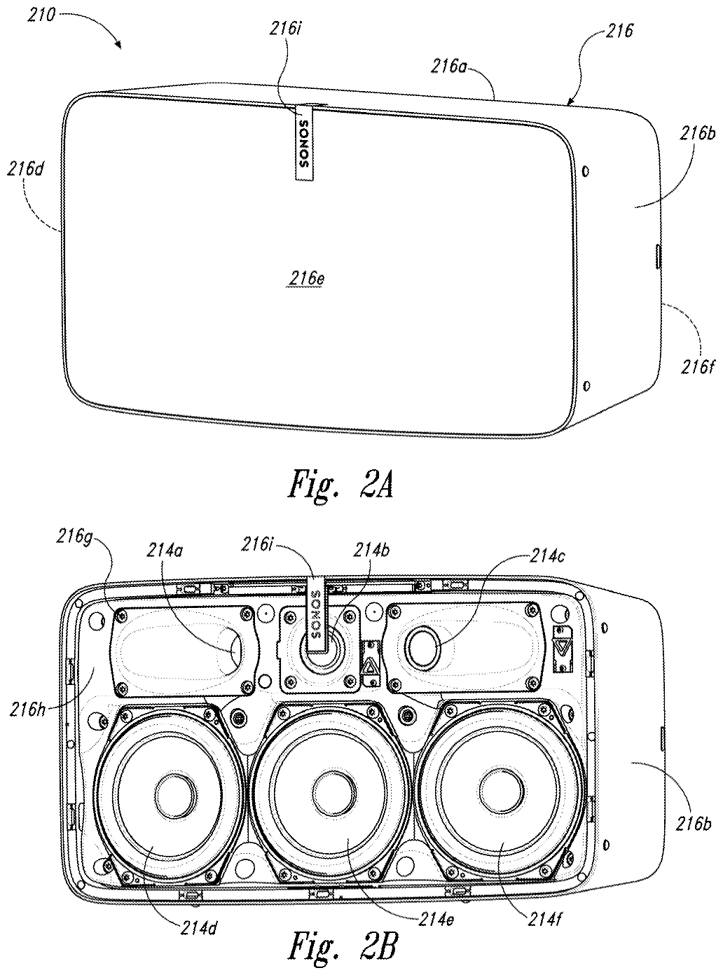

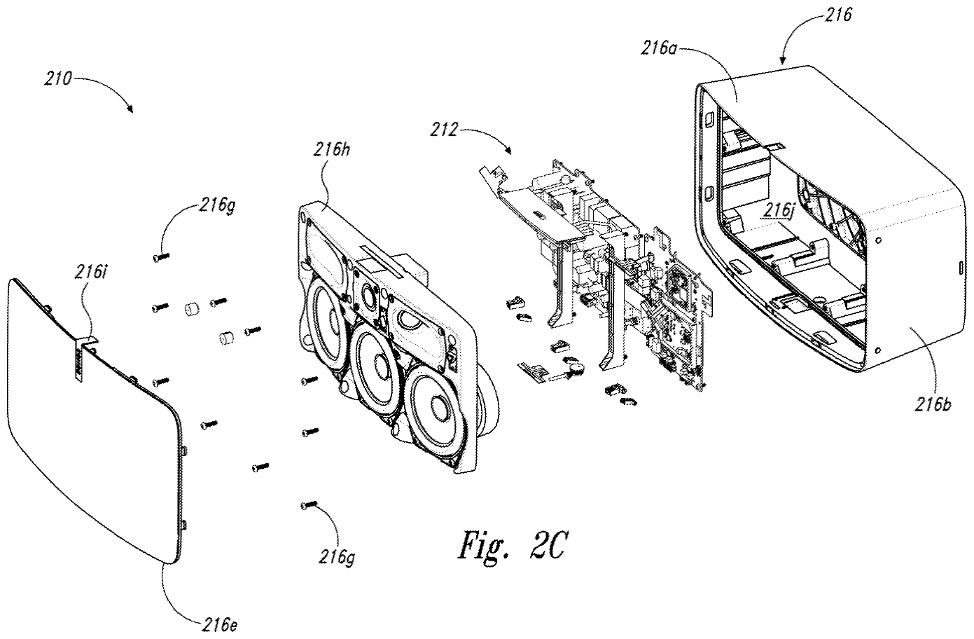

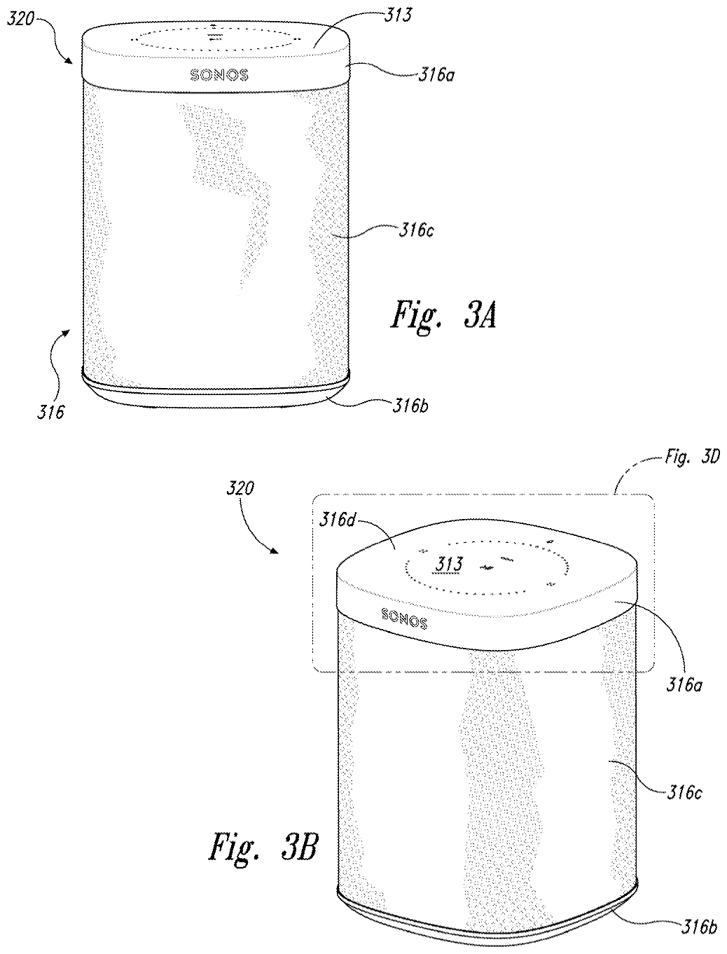

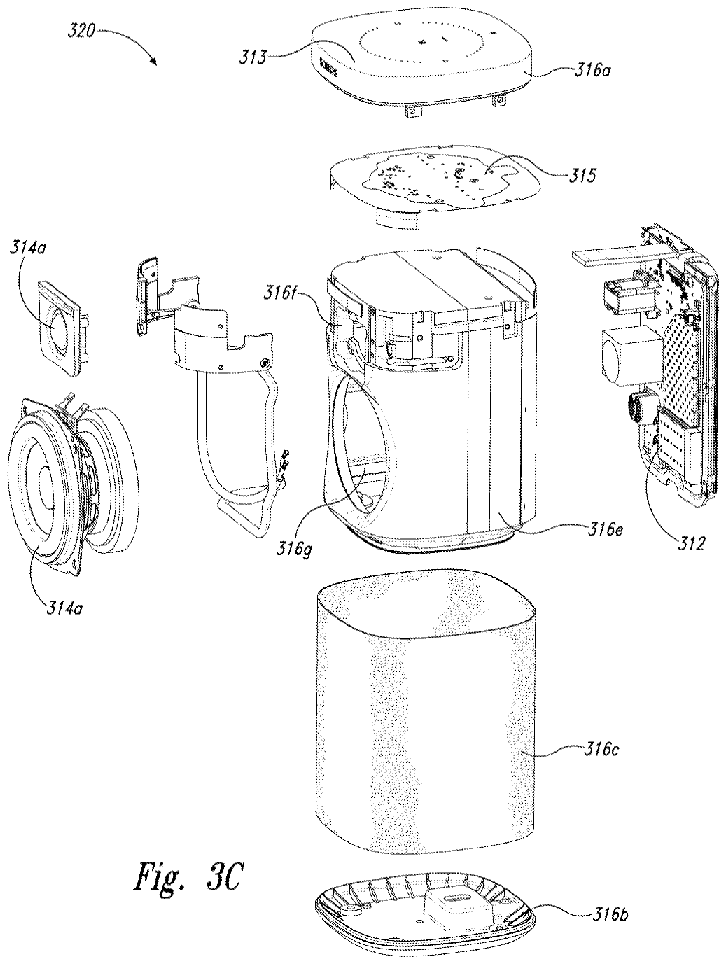

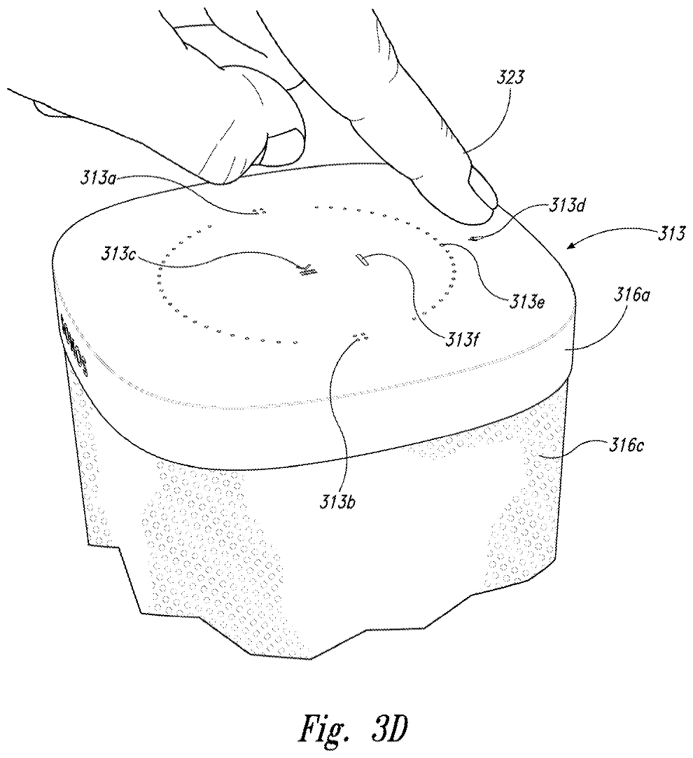

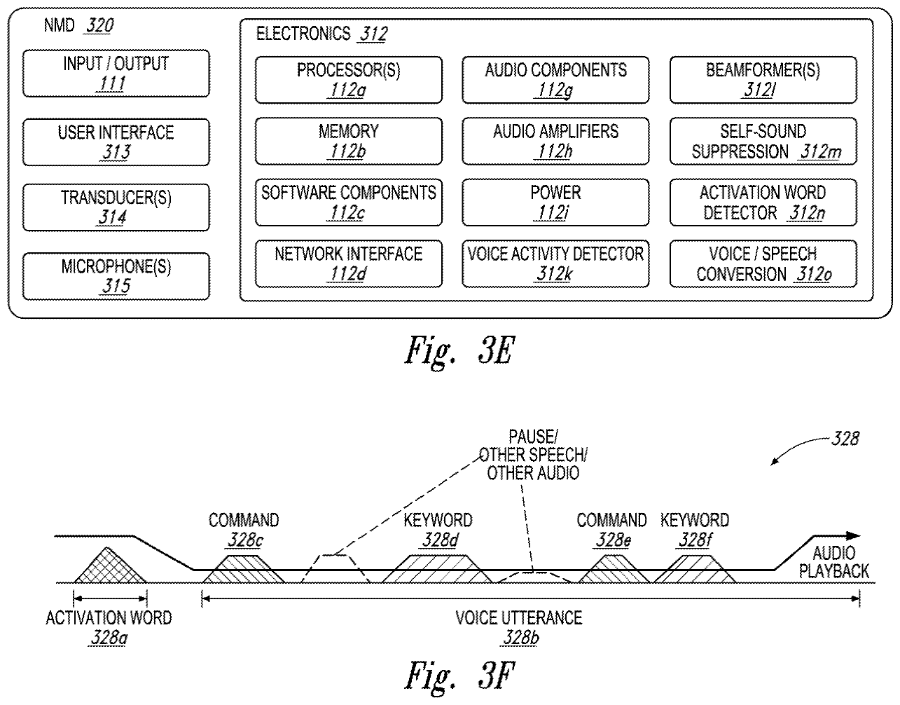

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some example configurations, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some example configurations, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some example configurations, the bonded playback device 110q includes additional playback devices and/or another bonded playback device. Additional playback device example configurations are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some example configurations, the NMD 120a is configured as a media playback device (e.g., one or more of the playback devices 110), and further includes, for example, one or more of the audio processing components 112g (FIG. 1C), the transducers 114, and/or other playback device components. In certain example configurations, the NMD 120a comprises an Internet of Things (IoT) device such as, for example, a thermostat, alarm panel, fire and/or smoke detector, etc. In some example configurations, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some example configurations, the NMD 120a includes additional components (e.g., one or more sensors, cameras, thermometers, barometers, hygrometers).

In some example configurations, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other example configurations, however, the playback device 110r receives commands from another control device (e.g., the control device 130a of FIG. 1B). Additional NMD example configurations are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some example configurations, the control device 130a comprises, for example, a tablet (e.g., an iPad™), a computer (e.g., a laptop computer, a desktop computer), and/or another suitable device (e.g., a television, an automobile audio head unit, an IoT device). In certain example configurations, the control device 130a comprises a dedicated controller for the media playback system 100. In other example configurations, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some example configurations, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some example configurations, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some example configurations, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some example configurations the control device 130a is configured as an NMD (e.g., one of the NMDs 120), receiving voice commands and other sounds via the one or more microphones 135.

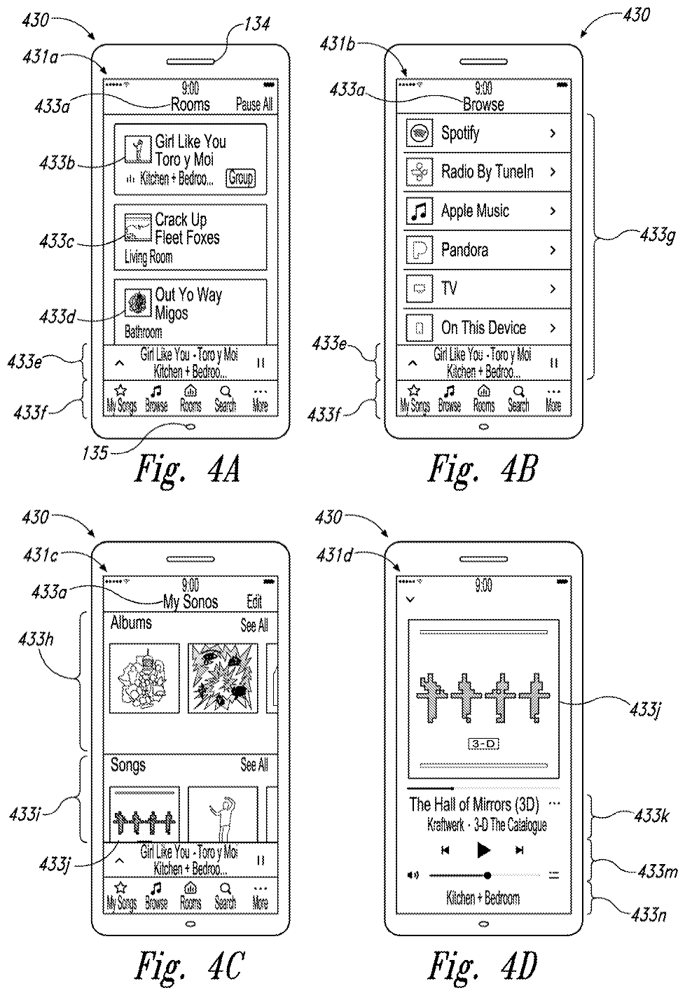

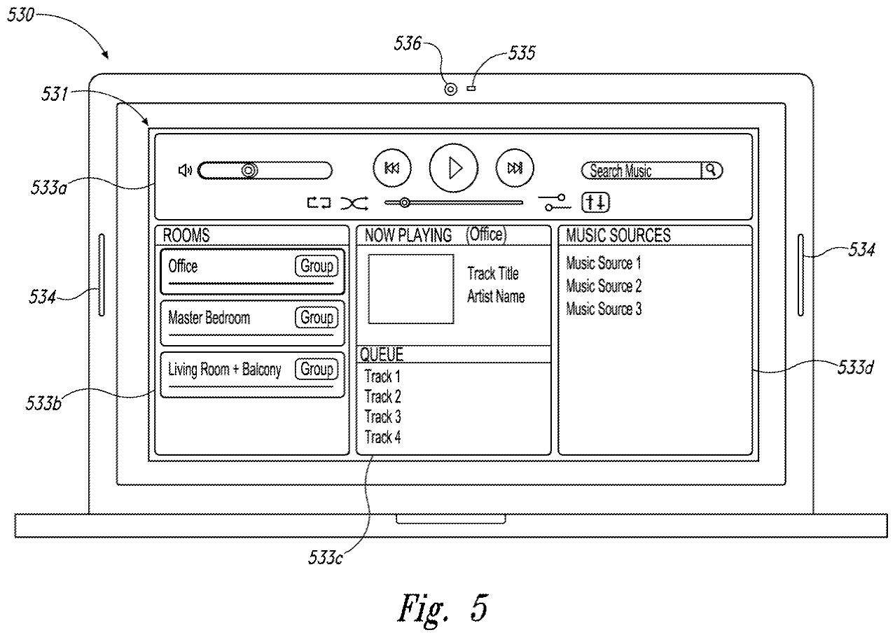

The one or more microphones 135 can comprise, for example, one or more condenser microphones, electret condenser microphones, dynamic microphones, and/or other suitable types of microphones or transducers. In some example configurations, two or more of the microphones 135 are arranged to capture location information of an audio source (e.g., voice, audible sound) and/or configured to facilitate filtering of background noise. Moreover, in certain example configurations, the control device 130a is configured to operate as playback device and an NMD. In other example configurations, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device example configurations are described in further detail below with respect to FIGS. 4A-4D and 5.

e. Suitable Playback Device Configurations

FIGS. 1-1 through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some example configurations, an NMD is bonded or merged with another device so as to form a zone. For example, the NMD 120b may be bonded with the playback device 110e, which together form Zone F, named Living Room. In other example configurations, a stand-alone network microphone device may be in a zone by itself. In other example configurations, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have be assigned a name such as “Dining+Kitchen”, as shown in FIG. 1M. In some example configurations, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some example configurations, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some example configurations, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some example configurations, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other example configurations, however, the playback device 210 includes more than six transducers (e.g., nine, ten). Moreover, in some example configurations, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some example configurations, however, the playback device 210 omits the filter 216i. In other example configurations, the playback device 210 includes one or more additional filters aligned with the transducers 214b and/or at least another of the transducers 214.

FIGS. 3A and 3B are front and right isometric side views, respectively, of an NMD 320 configured in accordance with example configurations of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 316 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other example configurations, however, the NMD 320 includes a single transducer, or more than two (e.g., two, five, six) transducers. In certain example configurations, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some example configurations, for example, the electronics 312 comprises many or all of the components of the electronics 112 described above with respect to FIG. 1C. In certain example configurations, the electronics 312 includes components described above with respect to FIG. 1F such as, for example, the one or more processors 112a, the memory 112b, the software components 112c, the network interface 112d, etc. In some example configurations, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some example configurations, the user interface 313 includes additional or fewer control surfaces and illuminators. In one embodiment, for example, the user interface 313 includes the first indicator 313e, omitting the second indicator 313f Moreover, in certain example configurations, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some example configurations, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain example configurations, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some example configurations, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some example configurations, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some example configurations, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include a activation word portion 328a and a voice utterance portion 328b. In some example configurations, the activation word 557a can be a known activation word, such as “Alexa,” which is associated with AMAZON's ALEXA®. In other example configurations, however, the voice input 328 may not include a activation word. In some example configurations, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some example configurations, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some example configurations, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some example configurations, the control device 530 includes other interactions and implementations for grouping and ungrouping zones via the user interface 531. In certain example configurations, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some example configurations, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some example configurations, for example, a playlist can be added to a playback queue, in which information corresponding to each audio item in the playlist may be added to the playback queue. In some example configurations, audio items in a playback queue may be saved as a playlist. In certain example configurations, a playback queue may be empty, or populated but “not in use” when the playback zone or zone group is playing continuously streaming audio content, such as Internet radio that may continue to play until otherwise stopped, rather than discrete audio items that have playback durations. In some example configurations, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

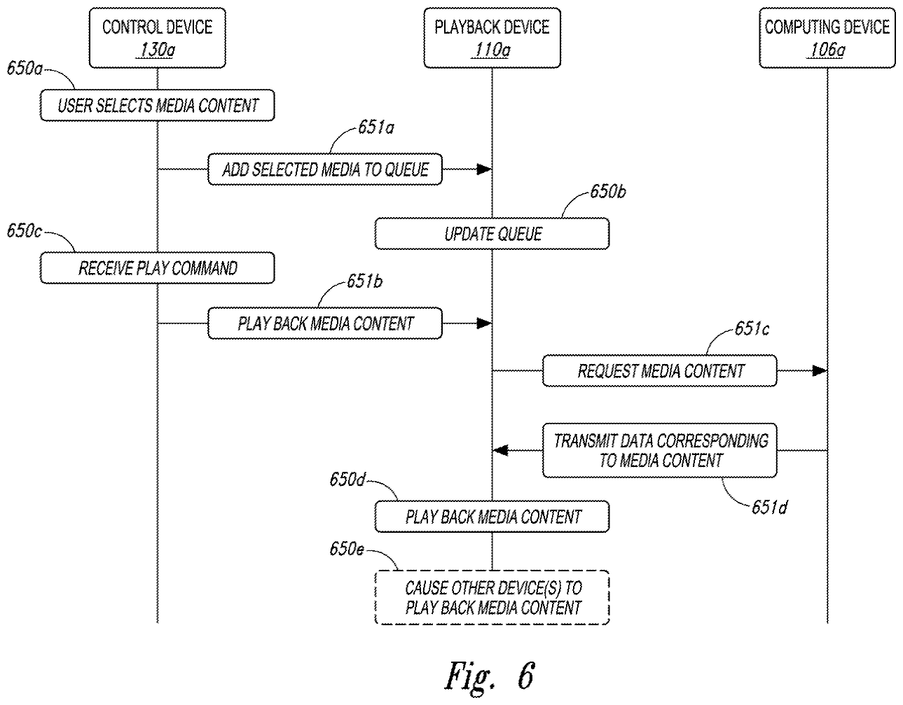

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Overview of Example Configurations

As summarized previously, example configurations disclosed herein can help ameliorate some of the technical problems that may arise with playback systems having large numbers of playback devices. For example, some configurations disclosed and described herein implement different combinations of unicasting, multicasting, and/or broadcasting audio content and playback timing in combination with Forward Error Correction (FEC) data in different network scenarios.

### V. Functional Components and Technical Features

In some example configurations, at least some aspects of the technical solutions derive from the functions performed by components of the playback system (e.g., audio sources, audio sourcing devices, group coordinators, group members, reference clocks, and so on) as well as the technical structure and organization of audio content, playback timing, and reference clock timing information, including (i) how audio sourcing devices use reference clock timing information to generate playback timing for audio content and (ii) how playback devices use the reference clock timing to play audio based on audio content and playback timing received from audio sourcing devices.

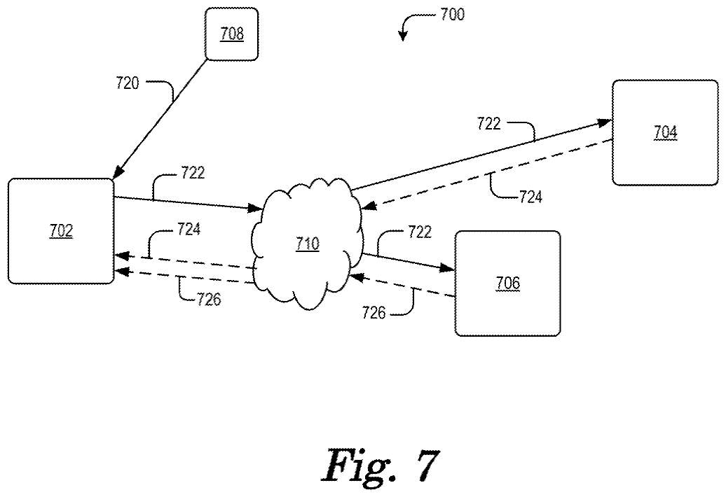

Therefore, to aid in understanding certain aspects of some example configurations disclosed herein, this section includes an overview of (i) certain functional details of playback system components, (ii) technical details of the audio content, playback timing, and reference clock timing information, and (iii) how audio sourcing devices use reference clock timing to generate playback timing and/or how playback devices use playback timing and reference clock timing to play audio. Except where noted, the technical details of the audio content, playback timing, and reference clock timing described herein are the same or substantially the same for all the examples shown and described with reference to FIGS. 7-9. However, this overview of functional components and technical features is provided to aid in the understanding aspects of the example configurations disclosed and described herein. Some example configurations may not implement every aspect of every technical feature described herein. Further, some example configurations may implement variations on the functions and features described herein.

a. Group Coordinator

A group coordinator is or comprises a networked computing device that is configured to perform group management functions for a playback group comprising one or more playback devices. The group coordinator may sometimes also be a playback device.

In some examples, the playback group comprises any of a synchrony group, a stereo pair, a bonded pair, a home theater group, or any other grouping of playback devices now known or later developed where the playback devices in the playback group are configured to play audio together in a groupwise manner.

In some examples, the group coordinator manages one or more functions of the playback group including but not limited to: (i) adding playback devices to the playback group, (ii) removing playback devices from the playback group, (iii) managing, storing, and/or otherwise maintaining a playback queue for the playback group, (iv) processing playback commands (e.g., start, stop, pause, fast forward, rewind, volume adjustments, and so on) for itself, for the playback group in a groupwise manner, and/or for individual group members (i.e., playback devices in the playback group) on an individual group member basis, and/or (v) acting as an interface or gateway via which a controller device (whether local to or remote from the group coordinator and/or playback system) can access and control individual playback devices or the playback group.

For example, in some scenarios, the group coordinator receives and processes playback commands, configuration commands, and/or other commands for the playback group that the group coordinator receives from any of a smartphone, tablet computer, laptop computer, desktop computer, network server, or other networked computing device running a software controller application configured to control the configuration and operation of the playback devices of the playback group individually or as a group.

In some example configurations, the group coordinator is also configured to function as an audio sourcing device and/or perform the audio sourcing device functions described further herein.

In some example configurations, the group coordinator additionally comprises or is configured to function as a reference clock and/or generate and/or provide reference clock timing information to playback devices in the playback group as described further herein.

In some example configurations, the group coordinator is a playback device that is a member of the playback group with one or more other playback devices (i.e., group members). In some such example configurations, the group coordinator is also configured to use the playback timing to play audio based on the audio content in a groupwise manner with the other group members, e.g., play the audio in synchrony with the other group members.

The group coordinator may also perform other functions not specifically identified herein, some of which might relate to managing operations of the playback group to facilitate groupwise playback of audio content by all of the playback devices within the playback group.

b. Group Member

A group member is or comprises a playback device that is part of a playback group.

In operation, a group member is configured to play audio in a groupwise manner with other playback devices in a playback group. In some configurations, an individual playback device is configured to play audio based on (i) audio content and playback timing received from an audio sourcing device and (ii) reference clock timing received from a reference clock.

In some example configurations where the group coordinator of a playback group is configured to perform the audio sourcing device and reference clock functions, individual playback devices within a playback group are configured to play audio based on audio content, playback timing, and reference clock timing received from the group coordinator.

In some example configurations, individual group members additionally use Forward Error Correction (FEC) data streamed from an audio sourcing device to correct errors in the audio content and/or playback timing received from the audio sourcing device.

In some example configurations, individual group members may additionally use FEC data streamed from networked computing device performing the reference clock function (which may be the same networked computing device performing the audio sourcing device and/or group coordinator functions, too) to correct errors in the reference clock timing information received from the reference clock and/or messaging relating to reference clock timing exchanged with the reference clock. Although any FEC data based on the reference clock and/or messaging relating to reference clock timing exchanged with the reference clock will necessarily be different from the FEC data based on the audio content and playback timing, any of the features and functions described herein with reference FEC data based on audio content and playback timing are equally applicable to FEC data based on the reference clock and/or messaging relating to reference clock timing exchanged with the reference clock.

In particular, any features or functionality described herein with reference to FEC data based on audio content and/or playback timing can be similarly implemented with separate FEC data on the reference clock and/or messaging relating to reference clock timing exchanged with the reference clock.

c. Audio Sourcing Device

An audio sourcing device is any network device that receives or otherwise obtains audio content from an audio source for processing and distribution to one or more playback devices. In some example configurations, the audio sourcing device may itself generate audio content in some scenarios, and in such scenarios, the audio source and the audio sourcing device may be the same device and/or application. As mentioned above, in some configurations, a playback device is configured to perform the group coordinator and audio sourcing device functions. But in other configurations, the audio sourcing device functions may be performed by a networked computing device different than the networked computing device configured to perform the group coordinator functions.

In some example configurations, an audio sourcing device obtains any of the types of audio content described herein from an audio source via an interface of the audio sourcing device, e.g., one of the audio sourcing device's network interfaces, a “line-in” analog interface, a digital audio interface, a “virtual line-in” interface (e.g., a software layer virtual abstraction that enables third party devices/IOT devices to connect wirelessly to the audio sourcing device to provide audio to the audio sourcing device for processing (and distribution, if applicable)), a network interface (e.g., a WiFi or Bluetooth interface) or any other interface suitable for receiving audio content in digital or analog format now known or later developed. In some example configurations, the audio sourcing device additionally or alternatively itself may generate the audio content. In some example configurations, the audio sourcing device obtains any of the types of audio content disclosed herein via one or more of a Wireless Local Area Network (WLAN) interface or a Personal Area Network (PAN) link (e.g., a Bluetooth or other PAN link) from an audio source, e.g., an audio streaming service, another playback device, a smartphone, a tablet computer, a smartwatch, or other computing device now known or later developed that is suitable for providing audio content to the audio sourcing device.

In some example configurations, the audio sourcing device transmits the processed audio content to all the playback devices configured to play audio based on the audio content. In some example configurations, the audio sourcing device transmits the processed audio content to all playback devices in a playback system (either via an individual unicast transmission, a multicast transmission, or a broadcast transmission), even playback devices that may not be configured to play audio based on that audio content. In some example configurations, the audio sourcing device transmits particular audio content to a particular multicast network address, and each playback device configured to play audio based on that particular audio content receives that particular audio content via that particular multicast address. In operation, receiving audio content via a particular multicast address in some example configurations requires a playback device to join or subscribe to a multicast group corresponding to that particular multicast address.

In some example configurations, the audio sourcing device receives audio content from an audio source in digital form, e.g., via an incoming stream of packets or frames. In some example configurations, individual packets or frames in the incoming stream have a sequence number or other identifier that specifies an ordering of the packets within the incoming stream. In operation, the audio sourcing device uses the sequence number or other identifier to detect missing packets or frames and/or to reassemble the packets or frames of the incoming stream in the correct order before performing further processing. In some example configurations, the sequence number or other identifier that specifies the ordering of the packets or frames is or at least comprises a timestamp indicating a time when the packet or frame was created. The packet/frame creation time is sometimes used as a sequence number based on an assumption that packets/frames are created in the order in which they should be subsequently played out.

For example, in some example configurations, individual packets from an audio source may include both a timestamp and a sequence number. In examples, the timestamp is may be used to place the incoming packets of audio content in the correct order, and the sequence number may be used to detect packet losses (i.e., missing packets). In operation, the sequence numbers increase by one for each Real-time Transport Protocol (RTP) packet transmitted from the audio source, and timestamps increase by the time “covered” by an RTP packet. In instances where a portion of audio content is split across multiple RTP packets, those multiple RTP packets can have the same timestamp.

In some example configurations, the audio sourcing device does not change the sequence number or identifier of a received packet during processing. In some example configurations, the audio sourcing device reorders at least a first set of packets in a first incoming packet stream received from an audio source (an inbound stream) based on each packet's sequence identifier, extracts audio content from the received packets, reassembles a bitstream of audio content from the received packets, and then repacketizes the reassembled bitstream into a second set of packets (an outbound stream), where packets in the second set of packets have sequence numbers and/or timestamps that differ from the sequence numbers and/or timestamps of the packets in the first set of packets (or first stream). The audio content in this outbound stream is sometimes referred to herein as processed audio content.

In some example configurations, individual packets in the second stream (i.e., the outbound stream) are a different length (i.e., shorter or longer) than individual packets in the first stream (i.e., the inbound stream). In some example configurations, reassembling a bitstream from the incoming packet stream and then subsequently repacketizing the reassembled bitstream into a different set of packets facilitates uniform processing and/or transmission of the processed audio content by the audio sourcing device and uniform processing by the playback devices that receive the processed audio content from the audio sourcing device.

However, for some delay-sensitive audio content, reassembly and repacketization may be undesirable, and therefore, in some example configurations, the audio sourcing device may not perform reassembly and repacketization for some (or all) audio content that it receives before distributing the audio content to playback devices. In such embodiments, the audio sourcing device distributes the delay-sensitive audio content to rendering devices with the same packetization as it was received by the audio sourcing device, with either (i) playback timing appended to the packets of audio content as overhead or (ii) playback timing provided separately from the packets of audio content and associated with the audio content (e.g., by providing timestamping data in the playback timing information that enables a rendering device to match up received playback timing with corresponding packets of audio content).

In example configurations described herein, the audio sourcing device additionally generates Forward Error Correction (FEC) data for the stream of audio content and playback timing that the audio sourcing device streams (or otherwise transmits) to playback devices configured to play the audio based on that audio content. In some example configurations where the audio sourcing device is additionally configured to provide reference clock timing to a playback group, the audio source may additionally generate FEC data for one or both of (i) the reference clock timing and/or (ii) other messaging relating to reference clock timing information that the audio sourcing device exchanges with individual playback devices.

In operation, the audio sourcing device can use any suitable FEC algorithm to generate the FEC data according to any known FEC data generation method now known or later developed that is sufficient for generating FEC data based on source data. In scenarios where the source data is or comprises a series of frames comprising audio content and playback timing for the audio content, the FEC data is based on the series of frames comprising the audio content and playback timing. And in scenarios where the source data is or comprises the reference clock timing and/or related messaging, the FEC data is based on the reference clock timing and/or related messaging.

As explained further herein, in some scenarios, the audio sourcing device may be configured to selectively implement several different FEC algorithms depending on the degree to which playback devices within the playback group are unable to successfully receive the audio content and playback timing (and/or perhaps additionally the reference clock timing and associated messaging) from the audio sourcing device.

d. Audio Content

The audio content referred to herein may be any type of audio content now known or later developed. For example, in some example configurations, the audio content includes any one or more of: (i) streaming music or other audio obtained from a streaming media service, such as Spotify, Pandora, Sonos Radio, or other streaming media services; (ii) streaming music or other audio from a local music library, such as a music library stored on a laptop computer, desktop computer, smartphone, tablet, music server, or other computing device or system now known or later developed; (iii) audio content associated with video content, such as audio content associated with a television program or movie received from any of a streaming video service, or any other source of audio-visual media content now known or later developed; (iv) text-to-speech or other audible information from a voice assistant service (VAS), such as Amazon Alexa, Google Assistant, Sonos Voice Control, or other VAS services now known or later developed; (v) audio content from alarms and alerts, such as smoke alarms, fire alarms, doorbells, or other types of devices and/or systems configured to generate alarms and/or alerts now known or later developed; (vi) audio content that is generated and/or triggered to play from or based on an interaction with an Internet of Things (IOT) device, such as internet enabled home appliances, security systems, thermostats, door locks/door openers, lights, photo frames, sensors, and/or any other IOT device now known or later developed that is configured to generate audio and/or cause audio to be generated; (vi) audio from a home automation/control device (or home control application running on a computing device) such as an Amazon Echo/Echo Dot, Google Nest/Nest Mini, Control4 Neeo Remote, Crestron Smart Control, and/or any other home automation/control device or system, and/or (vii) audio content from a public address (PA) or paging system, telephone, video phone, video/teleconferencing system or other application configured to allow users to communicate with each other via audio and/or video.

An audio source is any system, device, or application that generates, provides, or otherwise makes available any of the aforementioned audio content to an audio sourcing device, including but not limited to a playback device, a smartphone, a tablet computer, a smartwatch, a network server, a content service provider, a home appliance, a security system, industrial equipment, tools, a home control/automation system, or other computing system or device now known or later developed that is suitable for providing audio content to an audio sourcing device.

e. Playback Timing

As mentioned above, one of the functions performed by an audio sourcing device is to generate playback timing for audio content. In some examples, individual playback devices use the playback timing generated by the audio sourcing device to play audio based on the audio content received from the audio sourcing device.

In some example configurations, the audio sourcing device transmits the playback timing to each playback device by transmitting the playback timing to each playback device's unicast network address. In some example configurations, the audio sourcing device transmits the playback timing to all the playback devices in a playback group by transmitting the playback timing to a multicast network address for the playback group, and all the playback devices in the playback group receive the playback timing via the playback group's multicast address

In some example configurations, the audio sourcing device generates playback timing for individual frames (or packets) of processed audio content. As mentioned earlier, in some example configurations, the processed audio content is packaged in a series of frames (or packets) where individual frames (or packets) comprise a portion of the audio content. In some example configurations, the playback timing for the audio content includes a playback time for each frame (or packet) of audio content. In some example configurations, the playback timing for an individual frame (or packet) is included within the frame (or packet), e.g., in the header of the frame (or packet), in an extended header of the frame (or packet), and/or in the payload portion of the frame (or packet).

In some example configurations, the playback time for an individual frame (or packet) is identified within a timestamp or other indication. In such example configurations, the timestamp (or other indication) represents a time to play the one or more portions of audio content within that individual frame (or packet).

In operation, when the playback timing for an individual frame (or packet) is generated, the playback timing for that individual frame (or packet) is a future time relative to a current clock time of a reference clock at the time that the playback timing for that individual frame (or packet) is generated.

In operation, a playback device or any other playback device tasked with playing particular audio content will play the portion(s) of the particular audio content within an individual frame (or packet) at the playback time specified by the playback timing for that individual frame (or packet), as adjusted to accommodate for differences between the reference clock timing and a clock at the playback device (e.g., a rendering clock at a playback device).

In some example configurations described herein, the audio sourcing device streams (or otherwise transmits) a data stream that includes the audio content together with the playback timing for the audio content. In such scenarios where the audio sourcing device also generates FEC data for the audio content and playback timing, the audio sourcing device generates the FEC data based on the data stream comprising the audio content together with the playback timing for the audio content. In operation, the audio sourcing device can either (i) include the FEC data within the data stream comprising the audio content together with the playback timing for the audio content or (ii) transmit the FEC data in a data stream separate from the data stream comprising the audio content together with the playback timing for the audio content.

In some example configurations, the audio sourcing device transmits playback timing separately from the processed audio content. For example, the audio sourcing device transmits one stream comprising audio content to the playback devices in the playback group, and the audio sourcing device transmits a separate stream comprising playback timing for the audio content to the playback devices in the playback group period.

In such scenarios where the audio sourcing device also generates FEC data for the audio content and playback timing, the audio sourcing device generates (i) first FEC data based on the data stream comprising the audio content and (ii) second FEC data based on the data stream comprising the playback timing. With respect to the first FEC data, the audio sourcing device can either (i) include the first FEC data within the data stream comprising the audio content or (ii) transmit the first FEC data in a data stream separate from the data stream comprising the audio content. And with respect to the second FEC data, the audio sourcing device can either (i) include the second FEC data within the data stream comprising the playback timing or (ii) transmit the first FEC data in a data stream separate from the data stream comprising the playback timing.

Any of the features and functionality described herein with reference to FEC data based on a data stream comprising audio content and playback timing can be performed with (i) FEC data based on a data stream with just the audio content and/or (ii) FEC data based on just the playback timing. In some configurations, it may be advantageous to generate FEC data for audio content and separate FEC data for playback timing. But in other configurations, it may be advantageous to generate a single stream of FEC data for a data stream comprising both the audio content and playback timing.

f. Reference Clock and Reference Clock Timing Information

The audio sourcing devices disclosed and described herein use reference clock timing information to generate playback timing for audio content. And playback devices use reference clock timing information to play audio based on audio content and playback timing received from audio sourcing devices (e.g., group coordinators and/or other network devices configured to source audio content for playback systems).

In some example configurations, an audio sourcing device uses reference clock timing from a reference clock (e.g., a device clock, a digital-to-audio converter clock, a playback time reference clock, or any other clock) to generate playback timing for audio content that the audio sourcing device receives or otherwise obtains from an audio source. The reference clock can be a “local” clock at the audio sourcing device or a “remote” clock at a separate network device, e.g., a dedicated playback system clock, another playback device, a computing device, or another network device configured to provide clock timing for use by (i) an audio sourcing device to generate playback timing and/or (ii) a playback device to play audio based on the playback timing associated with the audio content. In some example scenarios, the playback system is configured to obtain clock timing from a “remote” clock at a network device via a Wide Area Network (WAN).

In some example configurations, each playback device in a synchrony group and/or other playback group or playback system tasked with playing particular audio content in a groupwise manner use the same reference clock timing information from the same reference clock to play back that particular audio content in synchrony with all the other playback devices in the playback group and/or other playback system. In some example configurations, playback devices use the same reference clock timing to play audio content that the audio sourcing device used to generate the playback timing for the audio content.

In some example configurations, the device that generates the reference clock timing also transmits the reference clock timing to (i) all the audio sourcing devices that need to use the reference clock timing for generating playback timing and (ii) all the playback devices that need to use the reference clock timing for playing back audio. In some example configurations, the device that generates the reference clock timing transmits the reference clock timing to a multicast network address, and (i) audio sourcing devices configured to generate playback timing receive the reference clock timing via that multicast address and (ii) playback devices configured to use the reference clock timing to play audio also receive the reference clock timing via that multicast address. In some example configurations, the device that generates the reference clock timing alternatively transmits the reference clock timing to each unicast network address of each other device that uses the reference clock timing, i.e., each audio sourcing device and each playback device.

In some example configurations, an individual playback device configured to play audio content determines one or more of (i) a difference between the reference clock time and a clock time of a rendering clock at the playback device (and/or vice versa), (ii) a difference between the clock rate of the reference clock and the clock rate of the rendering clock at the playback device (and/or vice versa), and (iii) whether and the extent to which the clock rate of the reference clock has drifted relative to the clock rate of the rendering clock at the playback device (and/or vice versa). In some example configurations, each playback device uses its own determined difference between the clock times, clock rates, and/or clock drift to (i) adjust received playback timing to account for the timing difference(s) and/or (ii) adjust a sample rate of the audio content to be played in connection with synchronous playback of the audio.

For example, instead of (or perhaps in combination with) adjusting playback timing described below, some example configurations alternatively (or additionally) include each playback device using the determined difference(s) between the reference clock timing and the rendering clock timing to facilitate one or both of (i) dropping one or more samples of audio content, e.g., not playing the dropped samples, thus effectively skipping those samples, and/or (ii) adding one or more samples of audio content, e.g., injecting small periods of silence (typically less than 15-20 milliseconds) during playback. By adjusting the sample rate of the audio content to be played based on differences in clock times, clock rates, and/or clock drift between the reference clock and the rendering clock, the playback device can in some instances facilitate the synchronous playback process by helping to account for the differences in the clock times, clock rates, and/or clock drift instead of (or in addition to) the timing offsets and timing advances described further herein in connection with playing audio based on the generated playback timing.

g. Generating Playback Timing

In some example configurations, for an individual stream of audio content, the audio sourcing device: (i) generates playback timing for the audio content based on clock timing from a reference clock (which may be either a local clock at the audio sourcing device or a clock at another network device separate from the audio sourcing device, e.g., a dedicated reference clock for a playback system), and (ii) transmits the generated playback timing to all the playback devices configured to play the audio content, e.g., all the playback devices configured to play that individual stream of audio content. In some example configurations, when generating playback timing for an individual frame (or packet) of audio content, the audio sourcing device adds a “timing advance” to the current clock time of the reference clock that the audio sourcing device is using for generating the playback timing.

In some example configurations, the “timing advance” is based on an amount of time that is greater than or equal to the sum of (i) the network transit time required for frames and/or packets comprising audio content transmitted from the audio sourcing device (e.g., a group coordinator or other sourcing device) to arrive at the playback device(s) and (ii) the amount of time required for all the playback devices (e.g., group members or other playback devices) to process received frames/packets from the audio sourcing device for playback.

In some example configurations, the audio sourcing device individually or in combination with one or more other networked computing devices determines a timing advance by sending one or more test packets to each playback device, and then receiving test response packets back from each playback device. In some example configurations, the audio sourcing device and the playback device negotiate (or otherwise individually or in combination determine) a timing advance via multiple test and response messages. In some example configurations with more than two playback devices, the audio sourcing device determines a timing advance by exchanging test and response messages with all of the playback devices in the playback group, and then setting a timing advance that is sufficient for the playback device having the longest total of network transmit time and packet processing time.

In some example configurations, the timing advance is less than about 50 milliseconds. In some example configurations, the timing advance is less than about 20-30 milliseconds. And in still further example configurations, the timing advance is less than about 10 milliseconds. In some example configurations, the timing advance remains constant after being determined, or at least constant for the duration of a playback session or perhaps constant during playback of an individual item of audio content (e.g., an individual track, an individual audio message, or similar item of content). In other example configurations, the audio sourcing device can change the timing advance in response to a request from a playback device indicating that a greater timing advance is required (e.g., because the playback device is not receiving packets in sufficient time to play the audio according to the playback timing) or a shorter timing advance would be sufficient (e.g., because the playback device is buffering more packets comprising portions of audio content than necessary to provide consistent, reliable playback).

In some scenarios, the audio sourcing device may be configured to generate individualized playback timing for one more individual group member in a playback group (or playback system). For example, in some scenarios, the audio sourcing device may incorporate each group member's specific “timing offset” (described further herein) into individualized playback timing generated and transmitted to that individual group member so that that individual group member can play the audio content according to its individualized playback timing received from the audio sourcing device rather than determining its own individualized playback timing based on the playback timing and its own individual “timing offset” relative to the reference clock (i.e., the clock used by the audio sourcing device to generate the playback timing). Configuring the audio sourcing device to generate individualized playback timing for one or more playback devices (and perhaps also performing other functions on behalf of a playback device) may in some instances enable playback groups and/or playback systems to be implemented with lower-cost playback devices that may have fewer processing capabilities than implementations where the playback groups and/or playback systems are implemented with fully-featured playback devices. Aspects of one playback device performing certain functions on behalf of another playback device are described in U.S. application Ser. No. 17/508,028, titled “Techniques for Enabling Interoperability between Media Playback Systems,” filed on Oct. 22, 2021, and currently pending. The entire contents of U.S. application Ser. No. 17/508,028 are incorporated herein by reference.

As described in more detail below, all the playback devices in a playback system configured to play the audio content in synchrony will use the playback timing and the reference clock timing to play the audio content in a groupwise manner (e.g., in synchrony with each other).

h. Generating Playback Timing with Clock Timing from a Remote Clock

In some example configurations, the audio sourcing device individually or in combination with one or more other networked computing devices, may generate playback timing for audio content based on reference clock timing information from a “remote” clock at another network device, e.g., another playback device, another computing device (e.g., a reference clock for the playback system, a smartphone, tablet computer, smartwatch, or other computing device configurable to provide reference clock timing sufficient for use by the audio sourcing device to generate playback timing). For example, in some example configurations, a system reference clock may be configured to generate and provide reference clock timing to several audio sourcing devices within a playback system. It can be more involved for an audio sourcing device to generate playback timing based on reference clock timing information from a remote reference clock (i.e., at another network device) than it is for the sourcing audio device to generate playback timing based on reference clock timing from a local reference clock at the audio sourcing device.

In some example configurations where the audio sourcing device generates playback timing for audio content based on reference clock timing from a separate reference clock, the playback timing that the audio sourcing device generates for an individual frame (or packet) is based on (i) a “timing offset” between (a) a local clock at the audio sourcing device that the audio sourcing device uses for generating the playback timing and (b) the reference clock timing from the remote reference clock, and (ii) a “timing advance” based on an amount of time that is greater than or equal to the sum of (a) the network transit time required (or at least desired) for packets transmitted from the audio sourcing device to arrive at the playback device(s) and (b) the amount of time required (or at least desired) for the playback device(s) to process frames and/or packets comprising audio content received from the audio sourcing device for playback.

For an individual frame (or packet) containing a portion(s) of the audio content, the audio sourcing device generates playback timing for that individual frame (or packet) by adding the sum of the “timing offset” and the “timing advance” to a current time of the local clock at the audio sourcing device that the audio sourcing device uses to generate the playback timing for the audio content. In operation, the “timing offset” may be a positive or a negative offset, depending on whether the local clock at the audio sourcing device is ahead of or behind the reference clock providing the reference clock timing. The “timing advance” is a positive number because it represents a future time relative to the local clock time at the audio sourcing device, as adjusted by the “timing offset.”

By adding the sum of the “timing advance” and the “timing offset” to a current time of the local clock at the audio sourcing device that the audio sourcing device is using to generate the playback timing for the audio content, the audio sourcing device is, in effect, generating the playback timing relative to the remote reference clock.

In some example configurations, and as described above, the “timing advance” is based on an amount of time that is greater than or equal to the sum of (i) the network transit time required for frames and/or packets comprising audio content transmitted from the audio sourcing device to arrive at the playback device(s) and (ii) the amount of time required for the playback device(s) to process received frames/packets from the audio sourcing device for playback.

In some example configurations, the audio sourcing device determines a timing advance via signaling between the audio sourcing device and the playback device(s), as described previously. Further, in some example configurations, the timing advance is less than about 50 milliseconds, less than about 20-30 milliseconds, or less than about 10 milliseconds, depending on the audio playback latency requirements because different audio may have different latency requirements.

For example, audio associated with video content may have lower latency requirements than audio that is not associated with video content because audio associated with video content must be (or at least should be) synchronized with its corresponding video content whereas audio that is not associated with video content need not be synchronized with any corresponding video content. In some example configurations, the timing advance remains constant after being determined, or at least constant for the duration of a playback session. And in some example configurations, the audio sourcing device can change the timing advance based on further signaling between the audio sourcing device (generating the playback timing) and the playback device(s) using the playback timing to play audio.

As described in more detail below, all the playback devices configured to play the audio content in synchrony will use the playback timing and the reference clock timing to play the audio content in synchrony with each other.

i. Playing Audio Using Local Playback Timing and Local Clock Timing

In some example configurations, the audio sourcing device may be a playback device configured to perform a group coordinator role for a playback group or playback system. In such example configurations, the group coordinator may be further configured to play audio in synchrony with other playback devices. And if the group coordinator is using clock timing from a local clock at the group coordinator to generate the playback timing (i.e., the group coordinator comprises the reference clock that generates the reference clock timing information), then the group coordinator can also play the audio using locally-generated playback timing and the locally-generated reference clock timing. In such example configurations, the group coordinator plays an individual frame (or packet) comprising portions of the audio content when the local reference clock that the group coordinator used to generate the playback timing reaches the time specified in the playback timing for that individual frame (or packet).

For example, recall that when generating playback timing for an individual frame (or packet), the audio sourcing device (which is a group coordinator in some example configurations) adds a “timing advance” to the current clock time of the reference clock used for generating the playback timing. In this instance, the reference clock used for generating the playback timing is a local clock at the group coordinator. So, if the timing advance for an individual frame is, for example, 30 milliseconds, then the group coordinator plays the portion (e.g., a sample or set of samples) of audio content in an individual frame (or packet) 30 milliseconds after creating the playback timing for that individual frame (or packet).

In this manner, an audio sourcing device acting as a group coordinator in such example configurations plays audio based on the audio content by using locally-generated playback timing and clock timing from a local reference clock at the group coordinator. As described further below, by playing the portion(s) of the audio content of an individual frame and/or packet when the clock time of the local reference clock reaches the playback timing for that individual frame or packet, the group coordinator plays that portion(s) of the audio corresponding to the audio content in that individual frame and/or packet in synchrony with the other playback device(s) configured to play that same audio content.

j. Playing Audio Using Local Playback Timing and Remote Clock Timing

As mentioned earlier, in some example configurations, an audio sourcing device generates playback timing for audio content based on clock timing from a remote clock, i.e., a clock at another network device separate from the audio sourcing device, e.g., a reference clock for the playback system, another playback device, or another computing device (e.g., a smartphone, laptop, media server, or other computing device configurable to provide clock timing sufficient for use by a playback device generate playback timing and/or playback audio). For scenarios where the audio sourcing device is also configured to the play the audio, the audio sourcing device uses the reference clock timing from the “remote” clock in connection with playing the audio. In such scenarios, the audio sourcing device plays audio using the locally-generated playback timing in combination with the reference clock timing from the remote clock.

Recall that, in example configurations where the audio sourcing device generates playback timing for audio content based on reference clock timing information from a remote clock, the audio sourcing device generates the playback timing for an individual frame (or packet) based on (i) a “timing offset” that is based on a difference between (a) a local clock at the audio sourcing device and (b) the reference clock timing from the remote reference clock, and (ii) a “timing advance” comprising an amount of time that is greater than or equal to the sum of (a) the network transit time required for frames/packets transmitted from the audio sourcing device to arrive at the playback device(s) and (b) the amount of time required for the playback device(s) to process frames and/or packets comprising audio content (i.e., processed audio content) received from the audio sourcing device for playback. And further recall that the audio sourcing device transmits the generated playback timing to the playback device(s) tasked with playing the audio in synchrony.

In a scenario where the audio sourcing device is configured to play the audio content in synchrony with one or more playback devices, then to play an individual frame (or packet) of audio content in synchrony with the playback device(s), the audio sourcing device subtracts the “timing offset” from the playback timing for that individual frame (or packet) to generate a “local” playback time for playing the audio based on the audio content within that individual frame (or packet). After generating the “local” playback time for playing the portion(s) of the audio corresponding to the audio content within the individual frame (or packet), the audio sourcing device plays the portion(s) of the audio corresponding to the audio content in the individual frame (or packet) when the local clock that the audio sourcing device is using to play the audio content reaches the “local” playback time for that individual frame (or packet). By subtracting the “timing offset” from the playback timing to generate the “local” playback time for an individual frame, the audio sourcing device effectively plays the portion(s) of audio corresponding to the audio content in that frame/packet with reference to the reference clock timing from the remote reference clock.

k. Playing Audio Using Remote Playback Timing and Remote Clock Timing

As mentioned above, an audio sourcing device transmits audio content and playback timing for the audio content to playback device(s), and a reference clock (which may be a component of the audio sourcing device but could also be separate from the audio sourcing device) provides reference clock timing information to playback device(s).

A playback device that receives the audio content, the playback timing, and the reference clock timing information from one or more networked devices (i.e., the audio sourcing device individually or in combination with a reference clock) is configured to play the audio using the playback timing from the device that provided the playback timing (i.e., remote playback timing from the audio sourcing device) and reference clock timing information from a reference clock at the device that provided the reference clock timing (i.e., remote clock timing from the reference clock). In this manner, the playback device in this instance plays audio based on audio content by using remote playback timing and remote reference clock timing information. This is the most typical scenario for the playback device example configurations disclosed and described herein.

To play an individual frame (or packet) of the audio content in synchrony with the other playback devices(s) tasked with playing the audio, the playback device (i) receives the frames (or packets) comprising the portions of the audio content, (ii) receives the playback timing for the audio content (e.g., in the frame and/or packet headers of the frames and/or packets comprising the portions of the audio content or perhaps separately from the frames and/or packets comprising the portions of the audio content), (iii) receives the reference clock timing information, and (iv) plays the portion(s) of the audio content in the individual frame (or packet) when the local rendering clock that the playback device uses for audio playback reaches the playback time specified in the playback timing for that individual frame (or packet), as adjusted by a “timing offset.” Some example configurations may additionally or alternatively include adjusting the sample rate of audio content based one or more timing differences between the reference clock (separate from the playback device) and the rendering clock (at the playback device).

In operation, after the playback device receives the reference clock timing information, the playback device determines a “timing offset” for the playback device. This “timing offset” comprises (or at least corresponds to) a difference between the “reference” clock that was used to generate the reference clock timing and a “local” rendering clock at the playback device that the playback device uses to play the audio content. In operation, a playback device that receives the reference clock timing from another device calculates its own “timing offset” based on the difference between its local rendering clock and the reference clock timing information, and thus, the “timing offset” that each playback device determines is specific to that particular playback device.

In some example configurations, when playing audio, the playback device generates new playback timing (specific to the playback device) for individual frames (or packets) of audio content by adding the previously determined “timing offset” to the playback timing for each received frame (or packet) comprising portions of audio content. With this approach, the playback device converts the playback timing for the received audio content into “local” playback timing for the playback device. Because each playback device calculates its own “timing offset,” each playback device's determined “local” playback timing for an individual frame is specific to that particular playback device.

And when the “local” rendering clock that the playback device is using for playing back the audio reaches the “local” playback time for an individual frame (or packet), the playback device plays the audio content (or portions thereof) associated with that individual frame (or packet). As described above, in some example configurations, the playback timing for a particular frame (or packet) is in the header of the frame (or packet). In other example configurations, the playback timing for individual frames (or packets) is transmitted separately from the frames (or packets) comprising the audio content.

Because each playback device plays frames (or packets) comprising portions of the audio content according to the playback timing as adjusted by its own “timing offset” relative to the reference clock timing information, and because the audio sourcing device that provides the playback timing also generated the playback timing for those frames (or packets) relative to the reference clock timing information, then each playback device plays the same frames (or packets) comprising the same portions of the audio content in synchrony with all of the other playback devices, i.e., at the same time or at substantially the same time.

In some example configurations, an individual playback device configured to play audio content determines one or more of (i) a difference between the reference clock time and a clock time of the rendering clock at the playback device (and/or vice versa), (ii) a difference between the clock rate of the reference clock and the clock rate of the rendering clock at the playback device (and/or vice versa), and (iii) whether and the extent to which the clock rate of the reference clock has drifted relative to the clock rate of the rendering clock at the playback device (and/or vice versa). In some example configurations, each playback device additionally uses its own determined difference between the clock times, clock rates, and/or clock drift to adjust a sample rate of the audio content to be played in connection with synchronous playback of the audio.

For example, in some example configurations, individual playback devices use one or more of the determined difference(s) between the reference clock timing and the rendering clock timing to facilitate one or both of (i) dropping one or more samples of audio content, e.g., not playing the dropped samples, thus effectively skipping those samples, and/or (ii) adding one or more samples of audio content, e.g., injecting small periods of silence (typically less than 15-20 milliseconds) during playback. By adjusting the sample rate of the audio content to be played based on differences in one or more of the clock times, clock rates, and/or clock drift between the reference clock and the rendering clock, individual playback devices can in some instances facilitate the synchronous playback process by helping to account for the differences in one or more of the clock times, clock rates, and/or clock drift instead of (or in addition to) the timing offsets and timing advances described herein in connection with playing audio based on the playback timing.

In particular, if the rendering clock at the playback device is running faster than the reference clock (i.e., the clock rate of the rendering clock is greater than the clock rate of the reference clock), then the playback device may need to inject a small period of silence during playback of an individual frame of audio content to account for the clock rate difference. Conversely, if the rendering clock at the playback device is running slower than the reference clock (i.e., the clock rate of the rendering clock is less than the clock rate of the reference clock), then the playback device may need to drop (not play) one or more audio samples during playback of an individual frame of audio content to account for the clock rate difference. In this manner, adjusting the sample rate by adding short “silent” samples or dropping audio samples during playback enables the playback device account for minor fluctuations in the clock rates. In some situations, making slight adjustments to the sample rate in this manner enable the playback devices to maintain high-quality synchronous playback without having to set new timing offsets for calculating new “local” playback timing, which could be more disruptive to playback in some instances as compared to minor sample rate adjustments.

### VI. Example Configurations

FIG. 7 shows a media playback system 700 according to some example configurations.

Media playback system 700 includes playback devices 702, 704, and 706 communicatively coupled to each other via a Local Area Network (LAN) 710. The playback devices 702, 704, and 706 are the same as or similar to any of the playback devices disclosed and described herein.

The LAN 710 may comprise any one or more wired and/or wireless networks and/or communications links configured to operate according to any wired and or wireless transmission protocol now known or later developed that is suitable for transmitting data between and among playback devices within a media playback system, or any suitable combination thereof. Although FIG. 7 shows the playback devices in system 700 exchanging data with each other via LAN 710 for ease of illustration, the features and functions disclosed and described herein are not limited to LAN implementations. For example, aspects of the features and functions described herein may be implemented by computing devices via any communication and/or networking infrastructure, including but not limited to Wide Area Networks (WAN), cellular data networks, Personal Area Networks (PAN) (e.g., Bluetooth or similar), or any other type of communication and/or networking infrastructure now known or later developed that is suitable for exchanging data communications.

In the example configuration shown in FIG. 7, the playback devices 702, 704, and 704 in the media playback system 700 are configured in a playback group. In the playback group, playback device 702 is configured to function as the group coordinator for the playback group, while playback device 704 and playback device 706 are each configured to operate as group members of the playback group.

In addition to functioning as the group coordinator for the playback group, playback device 702 is also configured to operate as an audio sourcing device for the playback group. When functioning as the audio sourcing device for the playback group, playback device 702 is configured to obtain audio content 720 from an audio source 708, process the audio content 720 to generate audio content 722 for distribution to the playback group (according to any of the audio processing techniques described herein), generate playback timing for the audio content 722 (according to any of the playback timing generation techniques described herein), and distribute the audio content 722 and the playback timing for the audio content 722 to the other playback devices 704 and 706 within the playback group (according to any of the audio content and playback timing transmission scenarios described herein).

Audio source 708 is the same as or similar to any of the audio source devices disclosed and described herein. Similarly, audio content 720 is the same as or similar to any of the audio content disclosed and described herein.

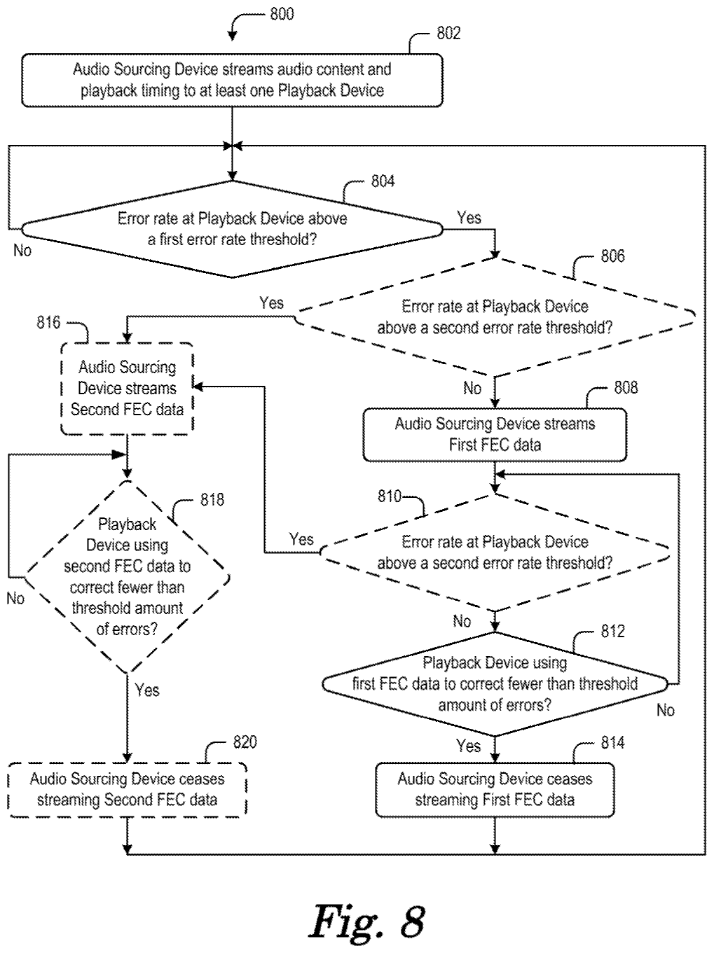

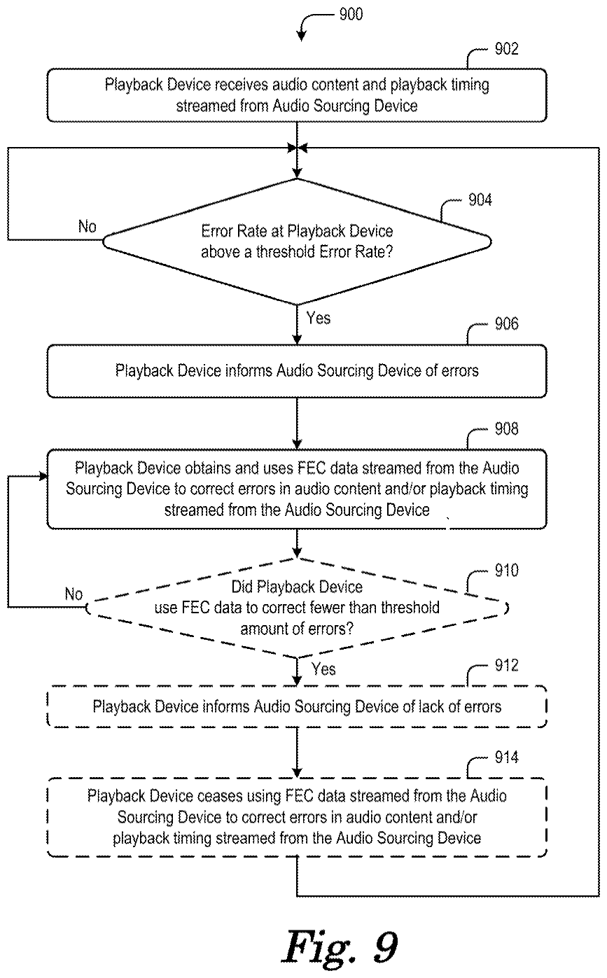

Details of the interactions between playback device 702 configured as the audio sourcing device and playback devices 704 and 706 configured as group members are described with reference to methods 800 and 900 in FIGS. 8 and 9, respectively. For example, playback device 702 is configured to perform any one or more (or all) of the functions shown and described with reference to method 800 in FIG. 8. Similarly, playback device 704, when functioning as a group member, is configured to perform any one or more (or all) of the functions shown and described with reference to method 900 and FIG. 9. Likewise, playback device 706, when functioning as a group member, is also configured to perform any one or more (or all) of the functions shown and described with reference to method 900 in FIG. 9.

FIG. 7 shows playback device 702 (as the audio sourcing device and group coordinator) transmitting audio content 722 and playback timing for the audio content 722 to both playback device 704 and playback device 706 via LAN 710. In the example configuration shown in FIG. 7, the playback device 702 is also configured to perform the reference clock function for the playback group, and thus, the playback device 702 is also configured to provide reference clock timing to the playback devices 704 and 706.

FIG. 7 also shows playback device 704 transmitting signaling information 724 back to playback device 702 via LAN 710, and playback device 706 transmitting signaling information back to playback device 702 via LAN 710. As explained in more detail with reference to methods 800 and 900, the signaling information 724, 726, that playback device 704 and playback device 706, respectively, transmit back to playback device 702 include, for example, acknowledgment indications (ACK), non-acknowledgment indications (NACK), information relating to error rates (e.g., bit error rates, block error rates, packet error rates, frame error rates, and or any other suitable error rate information), and/or information related to other network conditions (e.g., signal-to-noise ratio, receive power level, and/or other networking and/or transmission/reception metrics).

In some examples, signaling information 724, 726 may additionally or alternatively include explicit requests to playback device 702 for FEC data, e.g., FEC data based on the audio content (individually), FEC data based on the playback timing (individually), FEC data based on the reference clock timing and related messaging (individually), and/or FEC data based on a stream comprising both the audio content and playback timing.

Playback device 702 is also configured to stream FEC data to playback devices 702 and 704 according to any one or more (or all) of the methods and/or procedures disclosed and described with reference to methods 800 and/or 900. In some configurations, the FEC data corresponds to the audio content 722 and playback timing for the audio content 722.

For ease of illustration, FIG. 7 shows system 700 with a single playback group that includes one individual group coordinator 702 and two group members 704, 706, where the group coordinator 702 (configured to perform audio sourcing device and reference clock functions) performs aspects of implementing the FEC-related features and functions disclosed herein for the two group members 704, 706 of the single playback group. However, implementation of the FEC-related features and functions disclosed herein is not so limited.

For example, in some configurations, a playback system may have several playback groups (e.g., a first playback group, a second playback group, and a third playback group). In some configurations, each playback group may have its own corresponding group coordinator (e.g., a first group coordinator, a second group coordinator, and a third group coordinator) where each corresponding group coordinator performs FEC-related features and functions for the group member playback devices and its corresponding playback group independently from each other corresponding group coordinator for each other playback group.

In some examples, one playback device may be configured to operate as a group coordinator for two separate playback groups. For example, a playback system may have a first playback group, a second playback group, and a third playback group, where a first playback device is configured to operate as a first group coordinator for the first playback group and the second playback group, and a second playback device is configured to operate as a second group coordinator for the third playback group. In such an arrangement, the first group coordinator may be configured to perform FEC-related features and functions for the first playback group separately from FEC-related features and functions that the first group coordinator may perform for the second playback group, even in scenarios where the first playback group and the second playback group may be configured to play the same audio content.

### VII. Example Methods

FIG. 8 shows a method 800 performed by an audio sourcing device according to some example configurations. Aspects of method 800 are performed by an audio sourcing device while the audio sourcing device is streaming (or otherwise transmitting) audio content and playback timing to at least one playback device. Any networked computing device (e.g., a playback device) configured to perform audio sourcing device functions (including a group coordinator configured to perform audio sourcing device functions) can perform some (or all) aspects of method 800 and the variations thereof described herein.

FIG. 9 shows a method 900 performed by a playback device configured to use FEC data to correct errors in audio content and/or playback timing received from an audio sourcing device according to some example configurations. In some scenarios, method 900 is performed by a playback device functioning as a group member within a playback group. Aspects of method 900 and disclosed variations thereof are performed by a playback device while the playback device is receiving audio content and playback timing that is streamed from an audio sourcing device.

Methods 800 and 900 describe using FEC data in connection with correcting errors in audio content and playback timing. However, aspects of methods 800 and/or 900 are equally applicable to using FEC data in connection with correcting errors in reference clock timing information that playback devices use in combination with the playback timing to play audio based on the audio content streamed from the audio sourcing device. As such, any features and functions described with reference to audio content and playback timing in the context of methods 800 and 900 can additionally or alternatively performed for reference clock timing.

### A. Audio Sourcing Device Methods

Method 800 illustrates aspects of example methods that may be performed by configurations that use a single FEC algorithm and configurations that use multiple FEC algorithms. For example, in FIG. 8, method blocks 802, 804, 808, 812, and 814 relate to functions performed by some configurations that use a single FEC algorithm. And method blocks 806, 810, 816, 818, and 820 relate to additional functions performed by some configurations that use multiple FEC algorithms, e.g., two or more FEC algorithms.

Method 800 begins at method block 802, which includes the audio sourcing device streaming audio content and playback timing to at least one playback device.

The audio sourcing device may be the same as or similar to any of the audio sourcing device examples disclosed and described herein, including but not limited to playback device 702 (FIG. 7) configured to perform audio sourcing device functions. Similarly, the playback device may be the same as or similar to any of the playback device examples disclosed and described herein, including but not limited to playback devices 704 and 706 (FIG. 7).

In some example configurations, the audio sourcing device described with reference to method 800 is a playback device configured to perform the audio sourcing device functions as well as the group coordinator functions disclosed and described herein, and the playback device disclosed and described with reference to method 800 is configured as a group member in a playback group comprising at least the playback device and perhaps additional playback devices.

In some scenarios, the audio sourcing device may stream or otherwise transmit audio content and playback timing to several playback devices.

For example, in some scenarios, an audio sourcing device may stream or otherwise transmit audio content and playback timing to a playback group comprising several playback devices. In further scenarios, the audio sourcing device may stream or otherwise transmit audio content and playback timing to a playback system comprising several playback groups, where individual playback groups comprise several playback devices. As such, in some scenarios, the audio sourcing device may stream or otherwise transmit audio content and playback timing to many tens of playback devices, or perhaps even more than 100 playback devices within a playback system. But for ease of illustration, some aspects of method 800 are described with reference to a single playback device.

In operation, the audio content and playback timing are the same as or similar to any of the audio content and playback timing disclosed and described herein. For example, in some configurations, the audio sourcing device is configured to transmit the audio content and playback timing to the playback device via a stream comprising a series of frames where individual frames comprise audio content and/or playback timing as described previously.

1. Example Configurations Using a Single FEC Algorithm

After the audio sourcing device begins streaming audio content and playback timing to the at least one playback device at method block 802, method 800 advances to method block 804 which includes, while the audio sourcing device is streaming audio content and playback timing to at least the playback device (and possibly additional playback devices), the audio sourcing device determining whether the playback device has failed to successfully receive more than a threshold amount of the audio content and playback timing (sometimes referred to “audio data” or simply “data” herein) streamed from the audio sourcing device. For example, in some scenarios, determining whether the playback device has failed to successfully receive more than the threshold amount of the audio content and playback timing streamed from the audio sourcing device includes determining whether an error rate (i.e., the number of errors per a time duration) in the audio content and playback timing received at the playback device exceeds some threshold error rate. In operation, the error rate may correspond to a bit error rate, byte error rate, block error rate, packet error rate, frame error rate, or any other error rate that is suitable for determining whether the playback device has failed to successfully receive more than some threshold amount of the data (i.e., audio content and playback timing) streamed from the audio sourcing device.

Successful receipt of the audio content and playback timing in the context of some implementations of method 800 means that the playback device has received the audio content and playback timing from the audio sourcing device without errors that (individually or in combination) prevent or otherwise inhibit the playback device from using the audio content and playback timing to play audio based on the audio content and playback timing in a satisfactory manner.

In some situations, a playback device can simply skip playback of an occasional errored audio sample (i.e., play nothing during the errored sample playback time) and then resume playback of audio with the next successfully received audio sample—often with a barely perceptible (or perhaps imperceptible) disruption to playback. However, listeners will experience disruption to playback if or when a playback device receives more than some amount of errored data within a time period, e.g., as measured by any of the aforementioned bit error rate, block error rate, packet error rate, frame error rate, or other suitable measure of received errors or received error rate. Therefore, in some scenarios, when determining that the playback device has failed to successfully receive more than the threshold amount of the audio content and playback timing previously streamed from the audio sourcing device at method block 804, the audio sourcing device may use a threshold amount of errors corresponding to an error rate that is less than the error rate that would cause disruption to playback. By using an error rate that is less than the error rate that could cause disruption to playback, the audio sourcing device is able to identify potential future disruption to playback, and in some instances, begin streaming FEC data to the playback device (as described further herein) before the error rate reaches a sufficient level to cause disruption to playback.

In some scenarios, the threshold amount of successfully received audio content (and/or any corresponding threshold error rate) considered in method block 804 may be based on one or both of (i) the type of playback device and/or (ii) aspects of the playback system configuration.

For example, in a commercial implementation with hundreds of playback devices perhaps arranged into different playback groups playing different audio content (which may result in overlapping sounds near playback group boundaries), it may not be problematic (or even noticeable) for an individual playback device within a playback group to cease playback of audio content because of errors in the audio content and/or playback timing. Indeed, an individual playback device in such a scenario could cease playback for a few seconds or even a few minutes during a period of degraded network conditions without meaningfully affecting the overall playback group (or playback system) performance as long as other playback devices in the playback group can continue playing the audio content. However, in a home theater implementation with comparatively fewer playback devices and a comparatively higher expectation of greater audio fidelity, it could be quite disruptive for an individual playback device to cease playback of audio even for even a fraction of a second. As such, the threshold amount of successfully received audio content (and/or any corresponding threshold error rate) considered in method block 804 for the commercial implementation example may be higher than the threshold amount of successfully received audio content (and/or any corresponding threshold error rate) considered in method block 804 for the home theater implementation example.

In some scenarios, the audio sourcing device may determine that the playback device has failed to successfully receive more than the threshold amount of the audio content and/or playback timing streamed from the audio sourcing device at block 804 based on one or more of several indications, including but not limited to (i) one or more negative acknowledgement (NACK) messages received from the playback device, (ii) one or more retransmission requests for one or more portions of audio content and/or playback timing received from the playback device, (iii) a request received from the playback device for FEC data, (iv) an indication of one or more of a bit error rate, block error rate, packet error rate, frame error rate, and/or other suitable error rate metric received from the playback device, (v) a determination of a change in the bit error rate, block error rate, packet error rate, and/or change in other suitable error rate metric that indicates degrading network conditions, (vi) an indication of degraded network conditions, such as low signal-to-noise ratio, low receive power, or other indications of degraded network conditions received from the playback device, and/or (vii) a change in signal-to-noise ratio, receive power, or other indications of degrading network conditions.

For example, in some scenarios, the audio sourcing device may determine that the playback device has failed to successfully receive more than the threshold amount of the audio content and playback timing previously streamed from the audio sourcing device in block 804 based on acknowledgement (ACK) and/or negative acknowledgement (NACK) messages sent from the playback device to the audio sourcing device that indicate successful or unsuccessful receipt of individual portions (e.g., blocks, frames, packets, and so on), respectively. In some scenarios, when the playback device does not detect an error (e.g., via a parity check, cyclic redundancy check (CRC), or any other suitable error detection process) in the audio content and/or playback timing received from the audio sourcing device, the playback device notifies the audio sourcing device by sending a positive acknowledgement (ACK) message to the audio sourcing device. But if the playback device detects an error (e.g., via parity, CRC, or other error detection mechanism) in the audio content and/or playback timing received from the audio sourcing device, the playback device (i) discards the errored data (e.g., discards the errored bits, block(s), packet(s), frame(s), or other grouping(s) of data having the detected error(s)), and (ii) sends a negative acknowledgement (NACK) to the audio sourcing device to indicate the errored data. In some (but not necessarily all) instances, the playback device may additionally request that the audio sourcing device re-transmit the errored data. In some example scenarios, the audio sourcing device can use any one or more (or all) of the ACKs, NACKs, and/or retransmission requests received from the playback device at method block 804 to determine whether the playback device has failed to successfully receive more than the threshold amount of the audio content and playback timing previously streamed from the audio sourcing device.

In some example configurations, the audio sourcing device may additionally or alternatively use other indications to determine whether the playback device has failed to successfully receive more than the threshold amount of the audio content and playback timing previously streamed from the audio sourcing device in block 804. For example, the audio sourcing device may use network performance metrics reported by the playback device to either estimate errors or error rates, or alternatively, to estimate network conditions where high errors are likely to occur, e.g., low signal-to-noise ratio reported by the playback device, a low receive signal power level reported by the playback device, or other indications of degraded network conditions that are likely to contribute to errors in the data received by the playback device.

In some example configurations, rather than determining whether the playback device has failed to successfully receive more than the threshold amount of the data previously streamed from the audio sourcing device in block 804, the audio sourcing device at block 804 may instead determine whether the playback device is likely to experience errors based on, for example, low signal-to-noise ratio reported by the playback device, declining signal-to-noise ratio reported by the playback device, a low receive signal power level reported by the playback device, a declining receive signal power level reported by the playback device, or any other indication of degraded and/or degrading network conditions that would be likely to cause errors in the receipt of data received by the playback device, including (but not necessarily limited to) the audio content and playback timing streamed from the audio sourcing device.

If at block 804, the audio sourcing device does not determine (or perhaps estimate) that the playback device failed to successfully receive more than the threshold amount of data (or that the playback is likely to experience errors), i.e., if the audio sourcing device determines (or perhaps estimates) that the playback device is receiving sufficient error-free data (or is likely enjoying error-free receipt of data transmitted by the audio sourcing device), then, as indicated by the line from block 804 returning to block 804, the audio sourcing device continues (i) streaming the audio content and playback timing to the playback device and (ii) monitoring whether and the extent to which the playback device is experiencing errors (or monitoring whether and the extent to which the playback device is likely experiencing errors) and/or monitoring whether the playback device has failed to receive more than the threshold amount of data.

But if at block 804, the audio sourcing device determines (or perhaps estimates) that the playback device failed to successfully receive more than the threshold amount of data (or that the playback is likely experiencing errors), i.e., if the audio sourcing device determines (or perhaps estimates) that the playback device is not receiving sufficient error-free data (or is likely not enjoying error-free receipt of data transmitted by the audio sourcing device), then method 800 in some example configurations advances to block 808, which includes the audio sourcing device streaming FEC data for use by the playback device to correct errors in the data streamed from the audio sourcing device to the playback device.

Method blocks 806, 810, 816, 818, and 820 relating to additional functions performed by some configurations that use multiple FEC algorithms are described further below with reference to example configurations that use multiple FEC algorithms.

In some example configurations, the audio sourcing device generates the FEC data according to any FEC algorithm now known or later developed. In operation, generating the FEC data according to the FEC algorithm includes, for example, dividing portions of the data stream comprising audio content and playback timing into blocks of data, and generating FEC data for individual blocks comprising portions of audio content and playback timing. In some example scenarios, an individual block of data comprising audio content and playback timing may correspond to an individual frame (or packet) comprising audio content and playback timing. In other example scenarios, an individual block may include several frames (or packets) comprising audio content and playback timing for the audio content.

In some example configurations, method block 808 includes the audio sourcing device starting to generate the FEC data after the audio sourcing device at block 804 has determined that the playback device has failed to successfully receive more than the threshold amount of the data previously streamed from the audio sourcing device.

However, in other example configurations, the audio sourcing device may generate FEC data for the audio content and playback timing before the determination at block 804. For example, in some scenarios, the audio sourcing device may generate the FEC data in connection with generating the playback timing for the audio content, but not stream the FEC data associated with the audio content and playback timing unless and until there is a reason to stream the FEC data. For example, in some configurations, the audio sourcing device may not stream the generated FEC data unless and until, at method block 804, the audio sourcing device has determined that the playback device has failed to successfully receive more than the threshold amount of data, or that the playback device is likely experiencing errors in the data received from the audio sourcing device based on other indications and/or network metrics.

In some example configurations, rather than the audio sourcing device determining that the playback device has failed to successfully receive more than the first threshold amount of data at method block 804 based on indications of actual errors in the data received by the playback device, or estimating the likelihood of errors or error rates based on other network conditions, the audio sourcing device may instead receive an explicit request for the FEC data from the playback device, and in response, advance to method block 808 and start streaming the FEC data to the playback device after receiving (or perhaps in response to receiving) the request from the playback device for the FEC data.

In some configurations, the audio sourcing device streaming the FEC data for use by the playback device at block 808 includes the audio sourcing device streaming the FEC data to the playback device via unicast transmissions addressed to the playback device. In some instances, the audio sourcing device streams FEC data to individual playback devices separately via unicast transmissions to each such individual playback device.

In other configurations, the audio sourcing device streaming the FEC data for use by the playback device at block 808 includes the audio sourcing device streaming the FEC data to the playback device via multicast transmissions addressed to a multicast group that the playback device has joined. In some examples, the audio sourcing device streams the audio content, playback timing, and FEC data via multicast transmissions to a multicast group via which the playback device (and any other playback device subscribed to the multicast group) receives the audio content, playback timing, and FEC data from the audio sourcing device.

In some scenarios, the audio sourcing device streams the FEC data to the playback device(s) via different channels, different networks, and/or different transmission protocols than the channels, networks, and/or protocols via which the audio sourcing device streams the audio content and playback timing to the playback device(s), thereby reducing the likelihood that the network problems causing errors in the audio content and/or playback timing will also affect the stream of FEC data that the playback device(s) will use to correct the errors in the audio content and/or playback timing.

Accordingly, in some example configurations, the audio sourcing device streaming the FEC data for use by the playback device at block 808 includes the audio sourcing device streaming the FEC data via a first communications channel that is separate from a second communications channel via which the audio sourcing device is streaming the audio content and playback timing to the playback device. In some configurations, the audio sourcing device (i) streams the FEC data via the first communications channel via a first communication protocol, and (ii) streams the audio content and playback timing via a second communications channel via a second communication protocol that is different than the first communication protocol. In some configurations, the audio sourcing device streams the FEC data via a first wireless network that is separate from a second wireless network via which the audio sourcing device streams the audio content and playback timing.

As an example, in some scenarios, the audio sourcing device may (i) stream the audio content and playback timing to the playback device via a wireless LAN and (ii) stream the FEC data to the playback device via Bluetooth transmissions. As another example, the audio sourcing device may (i) stream the audio content and playback timing to the playback device via a 5.0 GHz wireless LAN and (ii) stream the FEC data to the playback device via a 2.4 GHz wireless LAN (or vice versa).

For scenarios where the FEC data is streamed separately from the audio content and playback timing via different communication mechanisms (i.e., different communication channels, different networks, and/or different protocols) the particular communication mechanisms used for the different streams may be based on any (or all) of (i) the types of playback devices, (ii) network capabilities and/or conditions of the communication mechanism via which the audio content and playback timing is streamed, (iii) network capabilities and/or conditions of the communication mechanism via which the FEC data is streamed, (iv) the “criticality” of high quality playback of the audio, and/or (v) other considerations.

For example, in a scenario where individual playback devices include 2.4 GHz and 5.0 GHz capability, and where high audio fidelity is expected, the audio content and playback timing may be transmitted via a 5.0 GHz wireless network link, and the FEC data may be transmitted via a 2.4 GHz wireless network link. In this arrangement, the high transmission speed and network bandwidth of the 5.0 GHz wireless network may enable the transmission of many streams of high quality (and high bandwidth) audio content to individual playback devices, and the comparatively greater reliability and stability of the 2.4 GHz wireless network may enable consistent and reliable transmission of (perhaps comparatively lower bandwidth) FEC data to playback devices. Because the FEC data in this example is transmitted via the 2.4 GHz wireless network, network problems that may cause errors in the audio content and playback timing received via the 5.0 GHz wireless network are unlikely to also affect the FEC data transmitted via the 2.4 GHz wireless network.

In a commercial implementation example comprising a large number of playback devices deployed over a large area, and where individual playback devices include Wi-Fi and cellular data capability, the audio content and playback timing may be transmitted via the Wi-Fi links, and the FEC data may be transmitted via cellular data network transmissions. In this arrangement, using the cellular data network to selectively provide the FEC data to individual playback devices on an as-needed basis may be more desirable than operating separate Wi-Fi networks as in the previously described example.

In some configurations, the audio sourcing device and an individual playback device may exchange messaging with each other to negotiate the communication mechanism via which the audio sourcing device streams the FEC data.

For example, in scenarios where the communication mechanism for streaming the audio content and playback timing and the communication mechanism for streaming the FEC data is not preconfigured, the audio sourcing device and the playback device may communicate with each other to determine a communication mechanism for streaming the FEC data based on several factors, including but not limited to (i) communication mechanisms available to both the audio sourcing device and the playback device, (ii) current network conditions for the communication mechanisms available to both the audio sourcing device and the playback device, and/or (iii) any preferred communication mechanism for both the audio sourcing device and the playback device.

In scenarios where the audio sourcing device and a playback device may have several available communication mechanisms, but only a single communication mechanism (e.g., one network, one protocol, etc.) is available to both the audio sourcing device and the playback device, then the audio sourcing device may stream the FEC data to the playback device via that single communication mechanism. For example, if the audio sourcing device has 2.4 GHz Wi-Fi, 5.0 GHz Wi-Fi, wired Ethernet, and cellular data communication mechanisms, and the playback device has 2.4 GHz and Bluetooth communication mechanisms, then the only communication mechanism common to both the audio sourcing device and the playback device is 2.4 GHz Wi-Fi, and thus, the audio sourcing device will stream the FEC data to the playback device via 2.4 GHz WiFi (which is the same communication mechanism via which the audio sourcing device streams the audio content and playback timing to the playback device).

In scenarios where an audio sourcing device and a playback device may have more than one available communication mechanism in common between them, then the audio sourcing device and the playback device may determine which communication mechanism to use based on current networking conditions for each available communication mechanism. For example, if the audio sourcing device has 2.4 GHz Wi-Fi, 5.0 GHz Wi-Fi, wired Ethernet, and cellular data communication mechanisms, and the playback device has 2.4 GHz Wi-Fi, 5.0 GHz Wi-Fi, and Bluetooth communication mechanisms, then the communication mechanisms common to both the audio sourcing device and the playback device are 2.4 GHz Wi-Fi and 5.0 GHz Wi-Fi. If the audio sourcing device is currently streaming the audio content and playback timing to the playback device via 2.4 GHz Wi-Fi when the playback device and/or audio sourcing device determine that the playback device needs the FEC data to correct errors, then the audio sourcing device and the playback device can decide whether to use the 2.4 GHz Wi-Fi or the 5.0 GHz Wi-Fi for streaming the FEC data.

For example, if the network conditions for the 2.4 GHz Wi-Fi are better (i.e., less congestion, better signal-to-noise ratio, etc.) than the network conditions of the 5.0 GHz Wi-Fi, then the audio sourcing device and/or the playback device may decide to use the 2.4 GHz Wi-Fi for the streaming the FEC data rather than the 5.0 GHz Wi-Fi. But if the network conditions for the 5.0 GHz Wi-Fi are better (i.e., less congestion, better signal-to-noise ratio, etc.) than the network conditions of the 2.4 GHz Wi-Fi, then the audio sourcing device and/or the playback device may decide to use the 5.0 GHz Wi-Fi for the streaming the FEC data rather than the 2.4 GHz Wi-Fi. If the network conditions for the 2.4 GHz Wi-Fi and the 5.0 GHz Wi-Fi are more or less similar, then the audio sourcing device and/or the playback device may decide to use one of the 2.4 GHz Wi-Fi or the 5.0 GHz Wi-Fi for streaming the FEC data based on one or more preferences. For example, if the playback device has a configured preference for receiving FEC data via the same communication mechanism as the audio content and playback timing (e.g., because using separate radios may be more computationally complicated and/or use more power than using a single radio), then based on this configured preference, the audio sourcing device and/or the playback device may decide to use the 2.4 GHz Wi-Fi for the streaming the FEC data rather than the 5.0 GHz Wi-Fi based on the configured preference (because, at least in this example scenario, the audio sourcing device is currently streaming the audio content and playback timing to the playback device via 2.4 GHz Wi-Fi).

In other example configurations, the audio sourcing device (i) streams the audio content and playback timing to the playback device via unicast transmissions to the playback device, and (ii) streams the FEC data via multicast transmissions to a multicast group that the playback device (or any other playback device) can join when the playback device needs to use the FEC data to correct errors in the audio content and/or playback timing received from the audio sourcing device.

In alternative configurations, the audio sourcing device (i) streams the audio content and playback timing to the playback device via multicast transmissions to a multicast group via which the playback device (and any other playback device subscribed to the multicast group) receives the audio content and playback timing from the audio sourcing device, and (ii) streams the FEC data via unicast transmissions to individual playback devices on a playback device by playback device basis, based on which playback devices should receive the FEC data (e.g., as determined at method blocks 804 and 806).

In further example configurations, the audio sourcing device (i) streams the audio content and playback timing to the playback device via multicast transmissions to a first multicast group via which the playback device (and any other playback device subscribed to the first multicast group) receives the audio content and playback timing from the audio sourcing device, and (ii) streams the FEC data via multicast transmissions to a second multicast group that the playback device (or any other playback device) can join when the playback device needs to use the FEC data to correct errors in the audio content and/or playback timing received from the audio sourcing device.

In still further example configurations, the audio sourcing device (i) streams the audio content and playback timing to the playback device via multicast transmissions to a first multicast group via which the playback device (and any other playback device subscribed to the first multicast group) receives the audio content and playback timing from the audio sourcing device, and (ii) streams the FEC data via broadcast transmissions to every playback device within the playback system.

And in still further example configurations, the audio sourcing device (i) streams the audio content and playback timing via broadcast transmissions to every playback device within the playback system, and (ii) streams the FEC data via broadcast transmissions to every playback device within the playback system.

In some example configurations, an individual playback device may be configured to receive several streams comprising audio content and playback timing, locally mix the different audio content from the different streams, and play the mixed audio. In such configurations, each individual stream of audio content and playback timing may also have corresponding FEC data associated therewith. In operation, the playback device may obtain and use the corresponding FEC data for each separate stream on a stream-by-stream basis as needed according to any of the features and functions described herein with reference to using FEC data in connection with a single stream comprising audio content and playback timing.

For example, if a playback device is configured to receive three separate streams (e.g., a first stream, a second stream, and a third stream), the playback device can selectively obtain and use each separate stream's corresponding FEC data (e.g., first FEC data for the first stream, second FEC data for the second stream, or third FEC data for the third stream) based on the quantity and/or rate of errors detected in the audio content and playback timing of each stream. If the playback device is detecting more than a threshold error rate for the first stream, then the playback device can obtain and use the first FEC data to correct the errors in the first stream, even if the playback device may be satisfactorily receiving the second and third streams (and thus, not obtaining or using the second FEC data or the third FEC data). Additional aspects of playback systems comprising playback devices configured to receive and locally mix audio content from two or more streams of audio content and play the mixed stream are described in more detail in U.S. Provisional App. 63/377,899, titled “Multichannel Content Distribution,” referred to as Docket No. 22-0207p (0400042), filed on Sep. 30, 2022, the contents of which are incorporated herein by reference.

After the audio sourcing device begins streaming the FEC data to the playback device at method block 808, some example configurations of method 800 advance to method block 812. As mentioned earlier, method block 810 relates to configurations that implement multiple FEC algorithms and is described further below with reference to example configurations that use multiple FEC algorithms.

Method block 812 may be optional in some configurations.

In some example scenarios, the audio sourcing device performs aspects of method block 812 while the audio sourcing device is streaming the FEC data for use by the playback device to correct errors in the audio data (including the audio content and/or playback timing) received by the playback device from the audio sourcing device. In some configurations, method block 812 includes the audio sourcing device determining whether the playback device has used the FEC data to correct fewer than a threshold number of errors in the audio data (including the audio content and/or playback timing) received from the audio sourcing device. In some examples, determining whether the playback device has used the FEC data to correct fewer than the threshold number of errors in the audio data received from the audio sourcing device includes determining an error correction rate and/or how often the playback device is actually using the FEC data to correct errors in the audio content and/or playback timing received from the audio sourcing device.

For example, if network conditions have improved such that the playback device is no longer using the FEC data to correct errors in the data received from the audio sourcing device, then the audio sourcing device may not need to continue generating and/or streaming the FEC data for use by the playback device. Similarly, if the playback device is only intermittently using the FEC data to correct errors in the data received from the audio sourcing device, then the audio sourcing device similarly may not need to continue generating or streaming the FEC data because, as explained above, in some situations, a playback device can simply skip playback of an occasional errored audio sample (i.e., play nothing during the errored sample playback time) and resume playback of audio with the next successfully received audio sample.

In some configurations, the audio sourcing device may determine that the playback device is no longer using the FEC data to correct errors (or using the FEC data to correct fewer than some threshold amount of errors) via any of the mechanisms by which the audio sourcing device initially determined whether the playback device was failing to successfully receive more than some amount of data as described above.

For example, in connection with determining whether the playback device is no longer using the FEC data to correct errors (or using the FEC data to correct fewer than some threshold amount of errors), the audio sourcing device may consider any one or more of: (i) one or more negative acknowledgement (NACK) messages (or lack thereof) received from the playback device, (ii) one or more retransmission requests for one or more portions of audio content and/or playback timing (or lack thereof) received from the playback device, (iii) a request for FEC data (or perhaps a message indicating that the playback device is no longer requesting the FEC data), (iv) an indication of one or more of a bit error rate, block error rate, packet error rate, frame error rate, and/or other suitable error rate metric received from the playback device, (v) a determination of a change in the bit error rate, block error rate, packet error rate, and/or change in other suitable error rate metric above a threshold that indicates satisfactory network conditions, (vi) an indication of improved network conditions, such as increased signal-to-noise ratio, increased receive power, or other indications of improved network conditions received from the playback device, and/or (vii) a change in signal-to-noise ratio, receive power, or other indications of improved and/or satisfactory network conditions.

If at method block 812, the audio sourcing device determines that the playback device has used the FEC data to correct fewer than the threshold number of errors in the audio content and playback timing received from the audio sourcing device, then method 800 advances to method block 814, which includes the audio sourcing device ceasing to stream the FEC data.

For example, if the audio sourcing device determines that the playback device is successfully receiving the audio content and playback timing (or at least successfully receiving sufficient audio content and playback timing to satisfactorily play the audio) such that the playback device no longer needs to use the FEC data to correct errors in data received from the audio sourcing device at block 812, then the audio sourcing device can cease transmitting the FEC data at block 814, and also perhaps cease generating the FEC data.

After ceasing streaming the FEC data at block 814, method 800 returns to method block 804 where, as indicated by the line from block 814 returning to block 804, the audio sourcing device continues (i) streaming the audio content and playback timing to the playback device and (ii) monitoring whether and the extent to which the playback device is experiencing errors (or monitoring whether and the extent to which the playback device is likely experiencing errors) to determine whether to resume streaming the FEC data.

But if at method block 812, the audio sourcing device determines that the playback device is continuing to use the FEC data to correct more than the threshold number of errors in the data received from the audio sourcing device, then method 800 returns to method block 810, where the audio sourcing device continues to monitor whether and the extent to which the playback device is using the FEC data to correct errors in the audio content and playback timing received from the audio sourcing device.

In some configurations where the audio sourcing device multicasts the FEC data to a multicast group associated with the FEC data, ceasing streaming the FEC data at method block 814 includes the audio sourcing device ceasing streaming the FEC data after determining that (i) the playback device has used the FEC data to correct fewer than the threshold number of errors in the data received from the audio sourcing device (or perhaps is no longer using the FEC data to correct errors in the data received from the audio sourcing device) and (ii) no other playback device in a group of two or more playback devices comprising at least the playback device has used the FEC data to correct more than the threshold number of errors in the audio content and/or playback timing (or perhaps is no longer using the FEC data to correct errors in the data received from the audio sourcing device).

In some configurations, ceasing streaming the FEC data at method block 814 includes the audio sourcing device ceasing streaming FEC data after determining that no other playback devices subscribed to the multicast group associated with the FEC data are still using the FEC data to correct errors in the audio content and playback timing received from the audio sourcing device. For example, in some configurations where the audio sourcing device multicasts the FEC data to a multicast group associated with the FEC data, the audio sourcing device is configured to continue multicasting the FEC data to the multicast group associated with the FEC data as long as at least one playback device subscribed to the multicast group associated with the FEC data is continuing to use the FEC data to correct errors in the audio content and/or playback timing received from the audio sourcing device.

In some example configurations, the audio sourcing device is configured to perform aspects of method 800 for each playback device in a playback group (or playback system comprising several playback groups) that is configured to play audio based on the audio content and playback timing streamed from the audio sourcing device.

For example, in some configurations, while the audio sourcing device is streaming the audio content and playback timing to a playback group comprising the playback device (i.e., a first playback device) and at least one additional playback device (i.e., a second playback device), and while the audio sourcing device is transmitting the FEC data to the first playback device via unicast transmissions, the audio sourcing device is configured to determine whether the second playback device is also experiencing sufficient errors (or a sufficient error rate) such that the second playback device has also failed to successfully receive more than the threshold amount of the data (e.g., audio content and/or playback timing) streamed from the audio sourcing device.

In some such configurations, the audio sourcing device is configured to determine whether the second playback device is also experiencing sufficient errors (or a sufficient error rate) such that the second playback device has also failed to successfully receive more than the threshold amount of the data (audio content and/or playback timing) streamed from the audio sourcing device in the same way (or in a similar way) that the audio sourcing device, at block 804, determined whether the first playback device had experienced sufficient errors (or a sufficient error rate) such that the first playback device effectively failed to successfully receive more than the threshold amount of the data (audio content and/or playback timing) previously streamed from the audio sourcing device.

After the audio sourcing device has determined that the second playback device has also failed to successfully receive more than the threshold amount of the data (audio content and/or playback timing) previously streamed from the audio sourcing device, the audio sourcing device in some example scenarios is configured to additionally stream FEC data to the second playback device via unicast transmissions in manner the same as or similar to how the audio sourcing device, at block 808, streams FEC data to the first playback device.

In some configurations, the audio sourcing device may be configured to additionally stream FEC data to each playback device within a playback group (or playback system) that would benefit from using the FEC data to correct errors in the audio content and playback timing streamed from the audio sourcing device based on the same considerations described herein with reference to method block 804.

2. Example Configurations Using Multiple FEC Algorithms

As mentioned above, method blocks 806, 810, 816, 818, and 820 relate to additional functions performed by some configurations that use multiple FEC algorithms.

Aspects of method blocks 804, 808, 812, and 814 described above with reference to configurations that use a single FEC algorithm are the same as or similar to method blocks 804, 808, 812, and 814 in configurations that use multiple FEC algorithms.

For example, regardless of the particular FEC algorithm used to generate FEC data, aspects of how the audio sourcing device streams the audio content, playback timing, and FEC data to one or more playback devices are the same (or similar to) for single FEC algorithm and multiple FEC algorithm configurations. In particular, regardless of whether the audio sourcing device is transmitting first FEC data generated according to a first FEC algorithm to one or more playback devices, or transmitting second FEC data generated according to a second FEC algorithm to the one or more playback devices, the audio sourcing device is configurable to transmit the audio content, playback timing, and the corresponding first FEC data or second FEC data to the one or more playback devices in any combination of wired, wireless, unicast, multicast, and/or broadcast implementations.

For example, the audio sourcing device in some configurations may any one or more of: (i) stream the audio content and playback timing together with its corresponding FEC data (first or second FEC data) via unicast transmissions to each playback device; (ii) stream the audio content and playback timing via unicast transmissions to each playback device separate from the corresponding FEC data (first or second FEC data); (iii) stream the audio content and playback timing together with its corresponding FEC data (first or second FEC data) via multicast transmissions to a multicast address corresponding to a multicast group to which the playback devices join/subscribe and via which the playback devices receive the audio content and playback timing together with its corresponding FEC data; (iv) stream the audio content and playback timing via multicast transmissions to a first multicast address corresponding to a first multicast group to which the playback devices join/subscribe to receive the audio content and playback timing, and stream the corresponding FEC data (first or second FEC data) via multicast transmissions to a second multicast address corresponding to a second multicast group to which playback devices can join/subscribe to receive the corresponding FEC data; (v) stream the audio content and playback timing to individual playback devices via unicast transmissions to each playback device and stream the corresponding FEC data (first or second FEC data) via multicast transmissions to a multicast address corresponding to a multicast group to which the playback devices may join/subscribe to receive the corresponding FEC data (first or second FEC data); or (vi) stream the audio content and playback timing via multicast transmissions to a multicast address corresponding to a multicast group to which the playback devices join/subscribe to receive the audio content and playback timing, and stream the corresponding FEC data (first or second FEC data) via unicast transmissions to individual playback devices (after determining to stream the corresponding FEC data to the individual playback devices). Similarly, any of the above listed unicast and multicast transmission scenarios may be implemented via any suitable communications media or combination of communication media, e.g., any suitable one or more wired transmissions and/or wireless transmissions via any suitable one or more transmission protocols as described previously with reference to example configurations that use a single FEC algorithm.

With respect to using multiple FEC algorithms, in some configurations, the audio sourcing device may be configured to use a second, stronger FEC algorithm in scenarios where a particular playback device is unable to correct errors by using a first FEC algorithm. Stronger FEC algorithms can enable a playback device to correct more severe errors in very poor networking conditions by generating and transmitting more FEC data as compared to the amount of FEC data generated by a comparatively less strong FEC algorithm.

As known in art, FEC encoding involves generating error correction data (the FEC data) based on the actual information to be transmitted (i.e., the audio content and playback timing in some examples) according an algorithm. The generated FEC data is then transmitted to a receiving device so that the receiving device can use the FEC data (i.e., the error correction data) to correct errors in the information received from the sender (i.e., the audio content and playback timing in some examples herein). Assuming a first FEC algorithm generates a first amount of FEC data based on a data block, and assuming a second FEC algorithm generates a second amount of FEC data (more than the first amount of FEC data) based on the same data block, the second FEC algorithm in some instances may be considered a stronger FEC algorithm than the first FEC algorithm because the second FEC algorithm generates more FEC data than the first FEC algorithm. More FEC data typically enables the receiver to correct more errors in the data block and/or more severe errors in the data block.

For example, while a first FEC algorithm may generate FEC data for the data block that is sufficient for correcting 1 or 2 individual errors within the data block, a second FEC algorithm may generate FEC data for the data block that is sufficient for correcting 3 or 4 errors within the data block. In another example, while a first FEC algorithm may generate FEC data for the data block that is sufficient for correcting 1 or 2 discrete errors within the data block, a second FEC algorithm may generate FEC data for that same data block that is sufficient for correcting 2 or 3 contiguous errors in the data block. In both of the above examples, the second FEC algorithm may be considered a stronger FEC algorithm than the first FEC algorithm because the second FEC algorithm is able to correct more errors and/or more severe errors (e.g., contiguous errors) within a data block.

But while the second, stronger FEC algorithm examples above can provide better error correction capabilities, the better error correction capabilities have corresponding computational and network bandwidth costs.

For example, because the stronger FEC algorithm results in more FEC data being generated and transmitted to the playback device, these stronger FEC algorithms can require more computing resources to implement the FEC encoding process at the audio sourcing device to produce the FEC data as compared to less complex FEC algorithms.

Additionally, the stronger FEC algorithms may also sometimes require more computing resources to implement the FEC decoding process at the playback device as compared to less complex FEC algorithms.

And because the stronger FEC algorithms generate more FEC data, they result in more data overall (the combination of the audio content, playback timing, and FEC data) being transmitted from the audio sourcing device to the playback device, which requires more network bandwidth as compared to less complex FEC algorithms that generate less FEC data. Transmitting more data (i.e., because of the additional FEC data) over a network that may already be experiencing congestion that is causing playback devices to experience errors in the audio content and playback timing can further exacerbate the network congestion that is contributing to the errors.

So in some situations, it may be advantageous for an audio sourcing device to use a first FEC algorithm to generate first FEC data and transmit that first FEC data to playback devices to use for correcting errors in the audio content and playback timing received from the audio sourcing device. And if one or more playback devices are unable to satisfactorily correct errors in the audio content and playback timing received from the audio sourcing device even with using the first FEC data, then the audio sourcing device can use a second, stronger FEC algorithm to generate second FEC data and stream that second FEC data to the playback device(s) for use in correcting errors in the audio content and playback timing received from the audio sourcing device.

In this manner, some example configurations enable the audio sourcing device to use stronger FEC algorithms in operational scenarios where one or more playback devices are experiencing error rates that would benefit from enhanced error correction capabilities provided by stronger FEC algorithms. In some scenarios, the audio sourcing device may be configurable to use different FEC algorithms in connection with transmitting data (i.e., audio content and playback timing) to different individual playback devices (including on a playback device by playback device basis) based on the extent to which each playback device is experiencing errors.

For example, for two separate playback devices (i.e., a first playback device and a second playback device), where both the first playback device and second playback device are both configured to play the same audio based on the same audio content and playback timing streamed from the audio sourcing device, the audio sourcing device in some scenarios may (i) stream first FEC data generated according to a first FEC algorithm to the first playback device, and (ii) stream second FEC data generated according to a second FEC algorithm to the second playback device. Further, the first playback device may then use the first FEC data to correct errors in the audio content and playback timing received from the audio sourcing device, and the second playback device may use the second FEC data to correct errors in the same audio content and playback timing received from the audio sourcing device.

In some configurations the first FEC algorithm comprises a Hamming Code based FEC algorithm, and the second FEC algorithm comprises a Golay Code based FEC algorithm, where the Golay Code based FEC algorithm generates more FEC data for the same amount of information (for the same sized data block) as compared to the Hamming Code based FEC algorithm. However, in some configurations, any other combination of FEC algorithms now known or later developed that are suitable for use in detecting errors in a data stream comprising audio content and playback timing could be used instead. Further, some configurations may include implementing more than two FEC algorithms. For example, some configurations may include implementing three or more FEC algorithms, each with increasing complexity and error-correction capability.

In some configurations, after the audio sourcing device in method block 804 has determined that the playback device has failed to successfully receive more than a first threshold amount of the audio content and playback timing previously streamed from the audio sourcing device, method 800 advances to method block 806, which includes determining whether the playback device has failed to successfully receive more than a second threshold amount of the audio content and playback timing previously streamed from the audio sourcing device, where the second threshold is higher than the first threshold.

For example, if the error rate experienced by the playback device is above a first threshold error rate (determined in block 804) but below a second threshold error rate (determined in block 806), then method 800 advances to block 808, which includes the audio sourcing device streaming first FEC data generated by the first FEC algorithm to the playback device. But if the error rate experienced by the playback device is above the first error rate (determined in block 804) and above the second threshold error rate (determined in block 806), then method 800 advances to block 816, which includes the audio sourcing device streaming second FEC data generated by the second FEC algorithm to the playback device.

In some configurations, the audio sourcing device is configured to select a FEC algorithm from a plurality of FEC algorithms to use for generating FEC data for an individual playback device based in part on error rates experienced by the playback device. For example, in some scenarios where the plurality of FEC algorithms comprises a first FEC algorithm and a second (stronger) FEC algorithm, if the error rate experienced by the playback device is above the first threshold error rate (determined in block 804) but below the second threshold error rate (determined in block 806), the audio playback device selects the first FEC algorithm and uses the first FEC algorithm to generate first FEC data for the playback device. But if the error rate experienced by the playback device is above the second threshold error rate (determined in block 806), the audio playback device selects the second FEC algorithm and uses the second FEC algorithm to generate second FEC data for the playback device.

In some scenarios, the audio sourcing device may determine that the playback device has failed to successfully receive more than the second threshold amount of the audio content and/or playback timing previously streamed from the audio sourcing device at block 806 based on the same or similar information and/or indications as used in block 804.

For example, the audio sourcing device may determine that the playback device has failed to successfully receive more than the second threshold amount of the audio content and/or playback timing previously streamed from the audio sourcing device at block 806 based on any one or more of several indications, including but not limited to (i) one or more negative acknowledgement (NACK) messages received from the playback device, (ii) one or more retransmission requests for one or more portions of audio content and/or playback timing received from the playback device, (iii) a request received from the playback device for FEC data, (iv) an indication of one or more of a bit error rate, block error rate, packet error rate, frame error rate, and/or other suitable error rate metric received from the playback device, (v) a determination in a change in the bit error rate, block error rate, packet error rate, and/or change in other suitable error rate metric that indicates degrading network conditions, (vi) an indication of degraded network conditions, such as low signal-to-noise ratio, low receive power, or other indications of degraded network conditions received from the playback device, and/or (vii) a change in signal-to-noise ratio, low receive power, or other indications of degrading network conditions.

For example, in some scenarios, the audio sourcing device may determine that the playback device has failed to successfully receive more than the second threshold amount of the audio content and playback timing streamed from the audio sourcing device in block 806 based on acknowledgement (ACK) and/or negative acknowledgement (NACK) messages sent from the playback device to the audio sourcing device that indicate successful or unsuccessful receipt of individual data blocks (or packets or frames), respectively.

In some example configurations, the audio sourcing device may additionally or alternatively use other indications to determine whether the playback device has failed to successfully receive more than the second threshold amount of the audio content and playback timing previously streamed from the audio sourcing device in block 806. For example, the audio sourcing device may use network performance metrics reported by the playback device to either estimate errors or error rates, or alternatively, to estimate conditions where higher errors are likely to occur, e.g., lower signal-to-noise ratios reported by the playback device, a lower receive signal power level reported by the playback device, and thereby estimate whether the audio sourcing device should stream the first FEC data generated by the first FEC algorithm (at block 808) or stream the second FEC data generated by the second FEC algorithm (at block 816).

If, at block 806, the audio sourcing device determines (or perhaps estimates) that the playback device did not fail to successfully receive more than the second threshold amount of data (e.g., the error rate is lower than a corresponding second error rate threshold), then, as indicated by the line from block 806 to block 808, method 800 advances to block 808 which includes the audio sourcing device transmitting the first FEC data generated by the first FEC algorithm to the playback device.

After the audio sourcing device starts streaming the first FEC data to the playback device at block 808, method 800 advances to method block 810. At method block 810, the audio sourcing device determines whether the error rate at the packet device is above the second error rate threshold. In some configurations, the second error rate threshold at block 810 is the same as the second error rate threshold at block 806. Further, in some examples, the audio sourcing device determines whether the error rate at the playback device is above the second error rate threshold at block 810 in the same manner that the audio sourcing device determined whether the error rate at the playback device was above the second error rate threshold at block 806.

By monitoring the error rate at the playback device to determine whether the error rate is above the second error rate threshold at block 810 after the audio sourcing device has started streaming the first FEC data (and the playback has started using the first FEC data to correct errors in the data received from the audio sourcing device), the audio sourcing device is able to determine whether the playback device is still able to use the first FEC data to successfully receive the audio content and playback timing streamed from the audio sourcing device while the audio sourcing device is continuing to stream the first FEC data.

If at block 810, the audio sourcing device determines that the error rate experienced by the playback device has risen above the second error rate threshold at block 810 while the audio sourcing device is streaming the first FEC data at block 808 (and the playback is using the first FEC data to correct errors in the data received from the audio sourcing device), then method 800 advances to block 816 which includes the audio sourcing device streaming the second FEC data (generated according to the stronger, second FEC algorithm). In some configurations, the audio sourcing device is able to switch from streaming the first FEC data to instead stream the second FEC data after (and perhaps in response to) determining that the playback device is unable to successfully receive some threshold amount of data (e.g., audio content and playback timing in some examples) even when using the first FEC data to try to correct errors in the data received from the audio sourcing device. This capability enables the audio sourcing device to increase the strength of the FEC algorithm being used to generate the FEC data as networking conditions change over time.

Additional aspects of method blocks 816-820 are described further below in connection with method 800 advancing to method block 816 from method block 806.

But if at block 810, the audio sourcing device determines that error rate remains below the second error rate threshold at block 810 while the audio sourcing device is streaming the first FEC data at 808 (and the playback is using the first FEC data to correct errors in the data received from the audio sourcing device), then method 800 advances to block 812 which includes the audio sourcing device determining whether the playback device has used the first FEC data to correct fewer than a threshold number of errors in the data received from the audio sourcing device. In some examples, determining whether the playback device has used the first FEC data to correct fewer than a threshold number of errors in the data received from the audio sourcing device includes determining an error correction rate and/or how often the playback device is actually using the first FEC data to correct errors in the audio content and/or playback timing received from the audio sourcing device.

For example, if network conditions have improved such that the playback device is no longer using the first FEC data to correct errors in the data received from the audio sourcing device, then the audio sourcing device may not need to continuing generating and/or streaming the first FEC data for use by the playback device. Similarly, if the playback device is only intermittently using the first FEC data to correct errors in the data received from the audio sourcing device, then the audio sourcing device similarly may not need to continue generating or streaming the first FEC data because, as explained above, in some situations, a playback device can simply skip playback of an occasional errored audio sample (i.e., play nothing during the errored sample playback time) and resume playback of audio with the next successfully received audio sample, often with a barely perceptible (or perhaps imperceptible) disruption to playback.

In some configurations, the audio sourcing device may determine that the playback device is no longer using the first FEC data to correct errors (or using the first FEC data to correct fewer than some threshold amount of errors) via any of the mechanisms by which the audio sourcing device initially determined whether the playback device was failing to successfully receive more than some threshold amount of data as described previously with reference to block 804.

For example, in connection with determining whether the playback device is no longer using the first FEC data to correct errors (or using the first FEC data to correct fewer than some threshold amount of errors), the audio sourcing device may consider any one or more of: (i) one or more negative acknowledgement (NACK) messages (or lack thereof) received from the playback device, (ii) one or more retransmission requests for one or more portions of audio content and/or playback timing (or lack thereof) received from the playback device, (iii) a request for FEC data (or perhaps an message indicating that the playback device is no longer requesting the FEC data), (iv) an indication of one or more of a bit error rate, block error rate, packet error rate, frame error rate, and/or other suitable error rate metric received from the playback device, (v) a determination of a change in the bit error rate, block error rate, packet error rate, and/or change in other suitable error rate metric above a threshold that indicates satisfactory network conditions, (vi) an indication of improved network conditions, such as increased signal-to-noise ratio, increased receive power, or other indications of improved network conditions received from the playback device, and/or (vii) a change in signal-to-noise ratio, receive power, or other indications of improved and/or satisfactory network conditions.

If at method block 812, the audio sourcing device determines that the playback device has used the first FEC data to correct fewer than the threshold number of errors in the audio content and playback timing received from the audio sourcing device, then method 800 advances to method block 814, which includes the audio sourcing device ceasing to stream the first FEC data.

For example, if the audio sourcing device determines that the playback device is successfully receiving the audio content and playback timing (or at least successfully receiving sufficient audio content and playback timing to satisfactorily play the audio) such that the playback device no longer needs to use the first FEC data to correct errors in data received from the audio sourcing device at block 812, then the audio sourcing device can cease transmitting the first FEC data at block 814.

After ceasing streaming the first FEC data at block 814, method 800 returns to method block 804 where, as indicated by the line from block 814 returning to block 804, the audio sourcing device continues (i) streaming the audio content and playback timing to the playback device and (ii) monitoring whether and the extent to which the playback device is experiencing errors (or monitoring whether and the extent to which the playback device is likely experiencing errors) to determine whether to resume streaming the FEC data.

But if at method block 812, the audio sourcing device determines that the playback device is continuing to use the first FEC data to correct more than the threshold number of errors in the data received from the audio sourcing device (e.g., the playback device is using the first FEC data to successfully correct errors at a correction rate that is higher than some corresponding correction rate threshold), then method 800 returns to method block 810, where the audio sourcing device continues to monitor whether and the extent to which the playback device is using the first FEC data to correct errors in the audio content and playback timing received from the audio sourcing device while the audio sourcing device continues streaming the first FEC data to the playback device.

In some configurations where the audio sourcing device multicasts the first FEC data to a multicast group associated with the first FEC data, ceasing streaming the first FEC data at method block 814 includes the audio sourcing device ceasing streaming the first FEC data after determining that (i) the playback device has used the first FEC data to correct fewer than the threshold number of errors in the data received from the audio sourcing device and (ii) no other playback device in a group of two or more playback devices comprising at least the playback device has used the first FEC data to correct more than the threshold number of errors. For example, in some configurations where the audio sourcing device multicasts the FEC data to a multicast group associated with the FEC data, the audio sourcing device is configured to continue multicasting the FEC data to the multicast group associated with the FEC data as long as at least one playback device subscribed to the multicast group associated with the FEC data is continuing to use the FEC data to correct errors in the audio content and/or playback timing received from the audio sourcing device.

Returning to block 806, if at block 806, the audio sourcing device determines (or perhaps estimates) that the playback device failed to successfully receive more than the second threshold amount of data (e.g., that the error rate is higher than a corresponding second error rate threshold), then, as indicated by the line from block 806 to block 816, method 800 advances to block 816 which includes the audio sourcing device transmitting the second FEC data generated by the stronger, second FEC algorithm to the playback device.

After the audio sourcing device has started streaming the second FEC data to the playback device at block 816, method 800 advances to method block 818 which includes determining whether the playback device has used the second FEC data to correct fewer than some threshold amount of errors. In some examples, determining whether the playback device has used the second FEC data to correct fewer than a threshold number of errors in the data received from the audio sourcing device includes determining an error correction rate and/or how often the playback device is actually using the second FEC data to correct errors in the audio content and/or playback timing received from the audio sourcing device.

For example, if network conditions have improved such that the playback device is no longer using the second FEC data to correct errors in the data received from the audio sourcing device, then the audio sourcing device may not need to continue generating and/or streaming the second FEC data for use by the playback device. Similarly, if the playback device is only intermittently using the second FEC data to correct errors in the data received from the audio sourcing device, then the audio sourcing device similarly may not need to continue generating or streaming the second FEC data because, as explained above, in some situations, a playback device can simply skip playback of an occasional errored audio sample (i.e., play nothing during the errored sample playback time) and resume playback of audio with the next successfully received audio sample.

In some configurations, the audio sourcing device may determine that the playback device is no longer using the second FEC data to correct errors (or using the second FEC data to correct fewer than some threshold amount of errors) via any of the mechanisms by which the audio sourcing device initially determined whether the playback device was failing to successfully receive more than some amount of data as described above (e.g., the same mechanisms for determining whether the error rate experienced by the playback device exceeded one of the first or second error rate thresholds).

For example, in connection with determining whether the playback device is no longer using the second FEC data to correct errors (or using the second FEC data to correct fewer than some threshold amount of errors), the audio sourcing device may consider any one or more of: (i) one or more negative acknowledgement (NACK) messages (or lack thereof), (ii) one or more retransmission requests for one or more portions of audio content and/or playback timing (or lack thereof), (iii) a request for FEC data (or perhaps an message indicating that the playback device is no longer requesting the FEC data), (iv) an indication of one or more of a bit error rate, block error rate, packet error rate, frame error rate, and/or other suitable error rate metric, (v) a determination in a change in the bit error rate, block error rate, packet error rate, and/or change in other suitable error rate metric above a threshold that indicates satisfactory network conditions, (vi) an indication of improved network conditions, such as increased signal-to-noise ratio, increased receive power, or other indications of improved network conditions, and/or (vii) a change in signal-to-noise ratio, receive power, or other indications of improved and/or satisfactory network conditions.

If at method block 818, the audio sourcing device determines that the playback device has used the second FEC data to correct fewer than the threshold amount of errors in the audio content and playback timing received from the audio sourcing device (or perhaps no longer using the second FEC data to correct errors), then method 800 advances to method block 820, which includes the audio sourcing device ceasing to stream the second FEC data. For example, if the audio sourcing device determines that the playback device is successfully receiving the audio content and playback timing (or at least successfully receiving sufficient audio content and playback timing to satisfactorily play the audio) such that the playback device no longer needs to use the second FEC data to correct errors in data received from the audio sourcing device at block 818, then the audio sourcing device can cease transmitting the second FEC data at block 820. After ceasing streaming the FEC data at block 820, method 800 returns to method block 804 where, as indicated by the line from block 820 returning to block 804, the audio sourcing device continues (i) sending the audio content and playback timing to the playback device and (ii) monitoring whether and the extent to which the playback device is experiencing errors (or monitoring whether and the extent to which the playback device is likely experiencing errors) to determine whether to resume streaming FEC data.

But if at method block 818, the audio sourcing device determines that the playback device is continuing to use the second FEC data to correct more than the threshold number of errors in the data received from the audio sourcing device, then method 800 returns to method block 818 where the audio sourcing device continues to monitor whether and the extent to which the playback device is using the second FEC data to correct errors in the audio content and playback timing received from the audio sourcing device.

In some configurations where the audio sourcing device multicasts the second FEC data to a multicast group, ceasing streaming the second FEC data at method block 820 includes the audio sourcing device ceasing streaming second FEC data after determining that no other playback devices subscribed to the multicast group associated with the second FEC data are still using the second FEC data to correct errors in the audio content and playback timing received from the audio sourcing device. For example, in some configurations where the audio sourcing device multicasts the second EC data to a multicast group associated with the second FEC data, the audio sourcing device is configured to continue multicasting the second FEC data to the multicast group associated with the second FEC data as long as at least one playback device subscribed to the multicast group associated with the second FEC data is continuing to use the second FEC data to correct errors in the audio content and/or playback timing received from the audio sourcing device.

### B. Methods Performed by a Playback Device Configured to Use FEC Data

FIG. 9 shows a method 900 performed by a playback device configured to use FEC data to correct errors in audio content and/or playback timing received from an audio sourcing device according to some example configurations.

The playback device(s) referred to in the context of method 900 may be the same as or similar to any of the example playback device configurations shown and described herein, including but not limited to playback devices 704 and/or 706 (FIG. 7). Similarly, the audio sourcing device(s) referred to in the context of method 900 maybe the same as or similar to any of the example audio sourcing device configurations shown and described herein, including but not limited to playback device 702 (FIG. 7) configured to perform audio sourcing device functions.

Method 900 begins at method block 902, which includes the playback device receiving audio content and playback timing streamed from an audio sourcing device. In operation, the audio sourcing device may stream the audio content and playback timing to the playback device, and the playback device may receive the audio content and playback timing streamed from the audio information source, according to any of the unicast, multicast, and/or broadcast methods described herein.

Next, method 900 advances to method block 904 which includes the playback device determining whether it has failed to successfully receive more than a threshold amount of the audio content and playback timing streamed from the audio sourcing device at block 902. For example, in some scenarios, the playback device may determine whether it has failed to successfully receive more than the threshold amount of the audio content and playback timing streamed from the audio sourcing device based at least in part on whether an error rate (i.e., the number of errors per a time duration) of the errors in the audio content and playback timing received at the playback device exceeds some threshold error rate. As mentioned previously, the error rate may correspond to a bit error rate, byte error rate, block error rate, packet error rate, frame error rate, or any other error rate that is suitable for determining whether the playback device has failed to successfully receive more than some threshold amount of the data (i.e., audio content and playback timing) streamed from the audio sourcing device.

Successful receipt of the audio content and playback timing by the playback device in the context of some example implementations of method 900 means that the playback device has received the audio content and playback timing from the audio sourcing device without errors that (individually or in combination) prevent or otherwise inhibit the playback device from using the audio content and playback timing to play audio based on the audio content and playback timing in a satisfactory manner.

In some situations, and as mentioned previously, the playback device can skip playback of an occasional errored audio sample (i.e., play nothing during the errored sample playback time) and then resume playback of audio with the next successfully received audio sample, often with a barely perceptible (or perhaps imperceptible) disruption to playback. However, listeners will experience disruption to playback if or when the playback device receives more than some amount of errored data within a time period, e.g., as measured by any of the aforementioned bit error rate, block error rate, packet error rate, frame error rate, or any other suitable measure of received errors or received error rate.

Therefore, in some scenarios, when the playback device is determining whether it has failed to successfully receive more than the threshold amount of the audio content and playback timing streamed from the audio sourcing device at method block 904, the playback device may use a threshold amount of errors corresponding to an error rate that is less than the error rate that would cause disruption to playback. By using an error rate that is less than the error rate that could cause disruption to playback, the playback device is able to identify potential future disruption to playback and begin receiving and using FEC data streamed from the audio sourcing device (as described further herein) in some instances before the error rate reaches a sufficient level to cause disruption to playback.

Next, method 900 advances to method block 906, which includes the playback device transmitting one or more messages to the audio sourcing device indicating (directly or indirectly) that the playback device has failed to successfully receive at least some audio content and/or playback timing streamed from the audio sourcing device.

In some scenarios, the one or more messages that the playback device sends to the audio sourcing device at method block 906 includes any one or more of (i) one or more negative acknowledgement (NACK) messages, (ii) one or more retransmission requests for one or more portions of audio content and/or playback timing, (iii) a request to receive FEC data, (iv) an indication of one or more of a bit error rate, block error rate, packet error rate, frame error rate, and/or other suitable error rate metric calculated and/or otherwise determined by the playback device, (v) a determination of a change in the bit error rate, block error rate, packet error rate, and/or change in other suitable error rate metric that indicates degrading network conditions, (vi) an indication of degraded network conditions, such as low signal-to-noise ratio, low receive power, or other indications of degraded network conditions, and/or (vii) a change in signal-to-noise ratio, low receive power, or other indications of degrading network conditions.

In some scenarios, method block 906 is optional. For example, in some configurations, the audio sourcing device (i) generates FEC data for the audio content and playback timing even when no particular playback device has explicitly indicated a need for the FEC data, and (ii) streams the generated FEC data to a multicast network address corresponding to a multicast group for receiving the FEC data. In such configurations, any playback device can join that multicast group and begin receiving (and using) the FEC data after (or perhaps in response to) determining that it (i.e., the playback device) has failed to successfully receive at least some audio content and/or playback timing streamed from the audio sourcing device at block 904 without needing to explicitly inform the audio sourcing device at block 906 of the errors that the playback device has experienced.

In some configurations that use multiple FEC algorithms, the audio sourcing device may be configured to stream separate FEC data generated according to separate FEC algorithms to separate corresponding multicast addresses, even when no particular playback device has explicitly indicated a need for the FEC data. In such configurations, the audio sourcing device (i) generates first FEC data for the audio content and playback timing based on a first FEC algorithm, (ii) streams the generated first FEC data to a first multicast network address corresponding to a first multicast group for receiving the first FEC data, (iii) generates second FEC data for the audio content and playback timing based on a second FEC algorithm, where the second FEC algorithm is stronger than the first FEC algorithm (as described previously) and (iv) streams the generated second FEC data to a second multicast network address corresponding to a second multicast group for receiving the second FEC data. In such example configurations, any playback device can join either the first multicast group or the second multicast group and begin receiving (and using) either the first FEC data or the second FEC data, respectively, after (or perhaps in response to) the playback device determining that it (i.e., the playback device) has failed to successfully receive at least some audio content and/or playback timing streamed from the audio sourcing device at block 904 without needing to explicitly inform the audio sourcing device at block 906 of the errors that the playback device has experienced.

In some configurations where the second FEC algorithm is stronger than the first FEC algorithm such as some configurations described with reference to method 800, the playback device may select to join one of the first multicast group corresponding to the first FEC data or the second multicast group corresponding to the second FEC data based on the extent to which the playback device is experiencing errors within the audio content and playback timing received from the audio sourcing device. For example, in some configurations, the playback device may join the first multicast group to receive and use the first FEC data when the number of errors detected in the data received from the audio sourcing device is above a first threshold error rate but below a second (higher) threshold error rate, and the playback device may join the second multicast group to receive and use the second FEC data when the number of errors detected in the data received from the audio sourcing device is above the second (higher) threshold error rate.

In some scenarios, the playback may send a message to the audio sourcing device requesting FEC data. In some configurations that use multiple FEC algorithms, the playback device may send a message to the audio sourcing device requesting one of several FEC data streams. For example configurations where the audio sourcing device is configured to generate first FEC data according to a first FEC algorithm and generate second FEC data according to a second FEC algorithm, the playback device may request to receive one of the first FEC data or the second FEC data from the audio sourcing device based upon the extent to which the playback device is experiencing errors in the data received from the audio sourcing device, e.g., based on whether the error rate of the errors detected in the data received from the audio sourcing device exceeds one or more threshold error rates similar the manner described previously.

In some example scenarios, if the playback device has been using first FEC data generated according to the first FEC algorithm to correct (or attempt to correct) errors in the audio content and/or playback timing streamed from the audio sourcing device, but the playback device is still failing to successfully receive more than the threshold amount of the audio content and/or playback timing even with using the first FEC data, the playback device in some scenarios may obtain and start using second FEC data that the audio sourcing device has generated according to the second, stronger FEC algorithm.

In some examples, the playback device may explicitly request the second FEC data from the audio sourcing device. In other examples, the audio sourcing device may determine that the playback device would benefit from using the second FEC data (e.g., based on NACK messages received from the playback device), and then start streaming the second FEC data for the playback device to receive and use. In further examples, the playback device may join a multicast group associated with the second FEC data, and thereafter begin receiving and using the second FEC data to correct errors in the audio content and/or playback timing received from the audio sourcing device.

After the playback device has determined that it has failed to successfully receive more than the threshold amount of the data streamed from the audio sourcing device at block 904 (and perhaps also after indicating as much to the audio sourcing device at block 906 at least in some scenarios), method 900 advances to block 908, which includes the playback device obtaining and using FEC data streamed from the audio sourcing device to correct errors in audio content and/or playback timing streamed from the audio sourcing device.

In some configurations, method block 908 may also include the playback device updating a “FEC state variable” to indicate that the playback device is currently using the FEC data to correct errors in the audio content and/or playback timing streamed from the audio sourcing device. In some configurations, the playback device may communicate the current state of this FEC state variable (e.g., indicating whether the playback device is (or is not) currently using the FEC data) to one or more external computing devices, e.g., a controller device and/or controller system running application software for monitoring and or controlling aspects of the playback system.

Communicating the current state of this FEC state variable to the external computing system running the controller application enables the controller application to display whether an individual playback device is currently using FEC data for a particular data stream. For scenarios where an individual playback device may be receiving several data streams, and thus, may use FEC data (or not) on a stream-by-stream basis, the playback device may implement a separate FEC state variable for each stream, thereby enabling the controller application to similarly display the current status of FEC use on a stream-by-stream basis.

In some instances where the controller application indicates that a particular playback device is currently using FEC data to correct errors on one or more streams, the controller application may also provide a suggestion or recommendation to improve one or more aspects of the network configuration that, if implemented, may tend to reduce the likelihood that the playback device may need to use the FEC data on one more streams of audio content and playback timing.

In some embodiments, the playback device may additionally include a local indication (e.g., a light or similar indication) that reflects the current state of the FEC state variable. For example, the playback device may illuminate a light (or change an illuminated light to a different color) to indicate when the playback device is using the FEC data for one or more streams of audio content and playback timing.

In some configurations, the playback device may receive the audio content and playback timing separate from the corresponding FEC data.

For example, in some configurations, the playback device may receive the audio content and playback timing via a first communication channel within a network, and receive the corresponding FEC data via a second communication channel within the same network. In other example configurations, the playback device may receive the audio content and playback timing via a first network (e.g., a 5.0 GHz wireless LAN), and receive the corresponding FEC data via a second network (e.g., a 2.4 GHz wireless LAN). In further example configurations, the playback device may receive the audio content and playback timing via a first communications protocol (e.g., Wi-Fi), and receive the corresponding FEC data via a second communications protocol (e.g., Bluetooth).

In operation, the playback device may receive the audio content, playback timing, and FEC data streamed from the audio sourcing device via any combination of unicast, multicast, and/or broadcast arrangements via which the audio sourcing device is configured to stream the audio content, playback timing, and FEC data, including but not limited to (i) receiving the audio content and playback timing together with its corresponding FEC data (first or second FEC data) via unicast transmissions addressed to the playback device; (ii) receive unicast transmissions comprising the audio content and playback timing separate from unicast transmissions comprising the corresponding FEC data (first or second FEC data); (iii) receive the audio content and playback timing together with its corresponding FEC data (first or second FEC data) via multicast transmissions to a multicast address corresponding to a multicast group to which the playback device has joined/subscribed; (iv) receive the audio content and playback timing via multicast transmissions to a first multicast address corresponding to a first multicast group to which the playback device has joined/subscribed to receive the audio content and playback timing, and receive the corresponding FEC data (first or second FEC data) via multicast transmissions to a second multicast address corresponding to a second multicast group to which the playback device has joined/subscribed to receive the corresponding FEC data; (v) receive the audio content and playback timing via unicast transmissions to the playback device and receive the corresponding FEC data (first or second FEC data) via multicast transmissions to a multicast address corresponding to a multicast group to which the playback device has joined/subscribed to receive the corresponding FEC data (first or second FEC data); or (vi) receive the audio content and playback timing via multicast transmissions to a multicast address corresponding to a multicast group to which the playback device has joined/subscribed to receive the audio content and playback timing, and receive the corresponding FEC data (first or second FEC data) via unicast transmissions to the playback device.

In some scenarios, method 900 additionally includes method blocks 910, 912, and 914.

In some examples, after the playback device obtains and starts using the FEC data streamed from the audio sourcing device to correct errors in the audio content and/or playback timing streamed from the audio sourcing device at method block 908, method 900 advances to method block 910 which includes the playback device determining whether it (the playback device) has used the FEC data to correct more or fewer than some threshold amount of errors.

If, at block 910, the playback device determines that it has used the FEC data to correct more than some threshold amount of errors (and thus, that it would be advantageous for the playback device to continue using the FEC data to correct errors), then method 900 returns to block 908, where the playback device continues to obtain and use the FEC data to correct errors in the audio content and/or playback timing streamed from the audio sourcing device.

But if at block 910, the playback device determines that it has used the FEC data to correct fewer than some threshold amount of errors (and thus, that the playback device may no longer need the FEC data to correct errors in the audio content and/or playback timing streamed from the audio sourcing device), then method 900 may in some scenarios advance to method block 912, which includes the playback device informing the audio sourcing device of its current error correction rate and/or informing the audio information source that the playback device is no longer using the FEC data to correct errors in the data received from the audio sourcing device period. Informing the audio sourcing device at block 912 may be advantageous in scenarios where the audio sourcing device only generates and/or streams FEC data in situations where the audio sourcing device has determined that one or more playback devices (i) need the FEC data to correct errors in the data received from the audio sourcing device and/or (ii) has explicitly requested the FEC data from the audio sourcing device.

After the playback device has determined at block 910 that it has used the FEC data to correct fewer than the threshold amount of errors (and also possibly informing the audio sourcing device of as much in method block 912), method 900 advances to method block 914, which includes the playback device ceasing to use the FEC data streamed from the audio sourcing device to correct errors in the audio content and/or playback timing streamed from the audio sourcing device.

After the playback device ceases using the FEC data at block 914, method 900 returns to method block 904, where the playback device continues to monitor the rate of errors detected in the audio content and/or playback timing received from the audio sourcing device to determine whether the playback device should obtain and use the FEC data again in the future.

### VIII. Conclusions

The above discussions relating to playback devices, controller devices, playback zone configurations, and media/audio content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative example configurations mutually exclusive of other example configurations. As such, the example configurations described herein, explicitly and implicitly understood by one skilled in the art, can be combined with other example configurations.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain example configurations of the present disclosure can be practiced without certain, specific details. In other instances, well known methods, procedures, components, and circuitry have not been described in detail to avoid unnecessarily obscuring aspects of the example configurations. Accordingly, the scope of the present disclosure is defined by the appended claims rather than the foregoing description of example configurations.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

What is claimed is:

1. A first playback device comprising:
one or more processors; and
tangible, non-transitory computer-readable media comprising program instructions that are executable by the one or more processors such that the first playback device is configured to:
while the first playback device is streaming data to at least a second playback device, determine whether the second playback device has failed to successfully receive more than a first threshold amount of the data previously streamed from the first playback device; and
after the first playback device has determined that the second playback device has failed to successfully receive more than the threshold amount of the data previously streamed from the first playback device, stream Forward Error Correction (FEC) data based on the data for use by at least the second playback device.

2. The first playback device of claim 1, wherein the program instructions comprise program instructions executable by the one or more processors such that the first playback device is configured to:
start generating the FEC data based on the data after the playback device has determined that the second playback device has failed to successfully receive more than the threshold amount of the data previously streamed from the first playback device.

3. The first playback device of claim 1, wherein the program instructions comprise program instructions that are executable by the one or more processors such that the first playback device is configured to:
select a FEC algorithm from a plurality of FEC algorithms based at least in part on an extent to which the second playback device has failed to successfully receive more than the threshold amount of the data previously streamed from the first playback device, wherein each FEC algorithm has a different corresponding strength; and
generate FEC data based on the data according to the selected one of the plurality of FEC algorithms.

4. The first playback device of claim 3, wherein the program instructions that are executable by the one or more processors such that the first playback device is configured to select the FEC algorithm from the plurality of FEC algorithms based at least in part on the extent to which the second playback device has failed to successfully receive more than the threshold amount of the data previously streamed from the first playback device comprise program instructions that are executable by the one or more processors such that the first playback device is configured to:
select a first FEC algorithm when the second playback device has failed to receive more than a first threshold amount of the data previously streamed from the first playback device but less than a second threshold amount of the data previously streamed from the first playback device; or
select a second FEC algorithm when the second playback device has failed to receive more than the second threshold amount of the data previously streamed from the first playback device, wherein the second FEC algorithm is a stronger FEC algorithm than the first FEC algorithm.

5. The first playback device of claim 1, wherein the FEC data based on the data comprises first FEC data generated according to a first FEC algorithm, and wherein the program instructions that are executable by the one or more processors such that the first playback device is configured to:
after transmitting the first FEC data generated according to the first FEC algorithm, determine that the second playback device has failed to successfully receive more than a threshold amount of the data even after using the first FEC data generated according to the first FEC algorithm to correct errors in the data; and
after determining that the second playback device has failed to successfully receive more than the threshold amount of the data even after using the first FEC data generated according to the first FEC algorithm to correct errors in the data, start transmitting second FEC data generated according to a second FEC algorithm, wherein the second FEC algorithm is a stronger FEC algorithm than the first FEC algorithm.

6. The first playback device of claim 1, wherein the program instructions comprise program instructions that are executable by the one or more processors such that the first playback device is configured to:
while the first playback device is streaming the FEC data based on the data, determine that the second playback device has used the FEC data to correct fewer than a threshold number of errors in the data received from the first playback device; and
after determining that the second playback device has used the FEC data to correct fewer than the threshold number of errors in the data received from the first playback device, cease streaming the FEC data.

7. The first playback device of claim 6, wherein the program instructions that are executable by the one or more processors such that the first playback device is configured to cease transmitting the FEC data comprises:
cease streaming FEC data based on the data after determining that (i) the second playback device has used the FEC data to correct fewer than the threshold number of errors in the data and (ii) no other playback device in a group of one or more playback devices comprising at least the second playback device has used the FEC data to correct more than the threshold number of errors in the data.

8. The first playback device of claim 1, wherein the program instructions that are executable by the one or more processors such that the first playback device is configured to stream FEC data based on the data for use by at least the second playback device comprise program instructions that are executable by the one or more processors such that the first playback device is configured to one of:
steam the FEC data to the second playback device via unicast transmissions addressed to the second playback device; or
stream the FEC data to the second playback device via multicast transmissions addressed to a multicast group that the second playback device has joined.

9. The first playback device of claim 1, wherein the program instructions that are executable by the one or more processors such that the first playback device is configured to stream FEC data based on the data for use by at least the second playback device comprise program instructions that are executable by the one or more processors such that the first playback device is configured to:
stream the FEC data via a first communications channel that is separate from a second communications channel via which the first playback device is streaming the data.

10. The first playback device of claim 9, wherein the program instructions that are executable by the one or more processors such that the first playback device is configured to stream the FEC data via a first communications channel that is separate from a second communications channel via which the first playback device is streaming the data comprise program instructions that are executable by the one or more processors such that the first playback device is configured to:
stream the FEC data via the first communications channel via a first communication protocol; and
stream the data to at least the second playback device via the second communications channel via a second communication protocol that is different than the first communication protocol.

11. The first playback device of claim 9, wherein the program instructions that are executable by the one or more processors such that the first playback device is configured stream the FEC data via a first communications channel that is separate from a second communications channel via which the first playback device is streaming the data comprise program instructions that are executable by the one or more processors such that the first playback device is configured to:
stream the FEC data via a first wireless network that is separate from a second wireless network via which the first playback device is streaming the data.

12. The first playback device of claim 1, wherein second playback device is a member of a group of one or more playback devices comprising at least the second playback device and a third playback device, and wherein the program instructions comprise program instructions that are executable by the one or more processors such that the first playback device is configured to:
while the first playback device is streaming the data to the group of one or more playback devices comprising at least the second playback device and the third playback device, determine whether the third playback device has failed to successfully receive more than a threshold amount of the data previously streamed from the first playback device; and
after the first playback device has determined that the third playback device has failed to successfully receive more than the threshold amount of the data previously streamed from the first playback device, stream additional FEC data for use by the third playback device.

13. The first playback device of claim 12, wherein the FEC data streamed for use by the second playback comprises first FEC data generated according to a first FEC algorithm, wherein the additional FEC data for use by the third playback device comprises second FEC data generated according to a second FEC algorithm, and wherein the first FEC algorithm is different than the second FEC algorithm.

14. A first playback device comprising:
one or more processors; and
tangible, non-transitory computer-readable media comprising program instructions that are executable by the one or more processors such that the first playback device is configured to:
while configured to play audio based on data streamed from a second playback device, determine whether the first playback device has failed to successfully receive more than a threshold amount of data previously streamed from the second playback device; and
after the first playback device has determined that it has failed to successfully receive more than the threshold amount of the data previously streamed from the second playback device, start using forward error correction (FEC) data streamed from the second playback device to correct errors in data streamed from the second playback device.

15. The first playback device of claim 14, wherein the program instructions comprise program instructions that are executable by the one or more processors such that the first playback device is configured to:
after the first playback device has determined that it has failed to successfully receive more than the threshold amount of the data previously streamed from the second playback device, and before the first playback device starts using FEC data streamed from the second playback device to correct errors in data streamed from the second playback device, transmit one or more messages to the second playback device indicating that the first playback device has failed to successfully receive at least some data previously streamed from the second playback device.

16. The first playback device of claim 15, wherein the one or more messages comprise one or more of (i) a negative acknowledgement (NACK) message, (ii) as retransmission request for one or more portions of audio content and/or playback timing, (iii) a request for FEC data, (iv) an indication of a bit error rate, (v) an indication of a packet error rate, and/or (vi) an indication of degraded network conditions.

17. The first playback device of claim 14, wherein the program instructions comprise program instructions that are executable by the one or more processors such that the first playback device is configured to:
after the first playback device has determined that it has failed to successfully receive more than the threshold amount of the data previously streamed from the second playback device, and before the first playback device starts using FEC data streamed from the second playback device to correct errors in data received from the second playback device, process FEC data streamed from the second playback device via one of (i) a transmission channel corresponding to the FEC data or (ii) a network address corresponding to the FEC data.

18. The first playback device of claim 14, wherein the program instructions comprise program instructions that are executable by the one or more processors such that the first playback device is configured to:
after the first playback device has determined that it has failed to successfully receive more than the threshold amount of the data previously streamed from the second playback device, and before the first playback device starts using FEC data streamed from the second playback device to correct errors in data streamed from the second playback device, join a multicast group associated with FEC data for the data, wherein after joining the multicast group, the first playback device is configured to receive the FEC data via a multicast address corresponding to the multicast group.

19. The first playback device of claim 14, wherein the program instructions that are executable by the one or more processors such that the first playback device is configured to start using FEC data streamed from the second playback device to correct errors in data streamed from the second playback device comprise program instructions that are executable by the one or more processors such that the first playback device is configured to one of one of:
start using the FEC data after receiving the FEC data from the second playback device via unicast transmissions addressed to the first playback device; or
start using the FEC data after receiving the FEC data from the second playback device via multicast transmissions addressed to a multicast group that the first playback device has joined.

20. The first playback device of claim 14, wherein the program instructions that are executable by the one or more processors such that the first playback device is configured to start using FEC data streamed from the second playback device to correct errors in data streamed from the second playback device comprise program instructions that are executable by the one or more processors such that the first playback device is configured to start using FEC data streamed from the second playback device to correct errors in data streamed from the second playback device after (i) receiving the FEC data via a first communications channel and (ii) receiving the data via a second communications channel that is separate from the first communications channel.

21. The first playback device of claim 14, wherein the program instructions that are executable by the one or more processors such that the first playback device is configured to start using FEC data streamed from the second playback device to correct errors in data streamed from the second playback device comprise program instructions that are executable by the one or more processors such that the first playback device is configured to start using FEC data streamed from the second playback device to correct errors in data streamed from the second playback device after (i) receiving the FEC data via a first communications channel according to a first communication protocol and (ii) receiving the data via a second communications channel according to a second communication protocol, wherein the second communication channel is separate from the first communication channel, and wherein the second communication protocol is different than the first communication protocol.

22. The first playback device of claim 14, wherein the program instructions that are executable by the one or more processors such that the first playback device is configured to start using FEC data streamed from the second playback device to correct errors in data streamed from the second playback device comprise program instructions that are executable by the one or more processors such that the first playback device is configured to start using FEC data streamed from the second playback device to correct errors in data streamed from the second playback device after (i) receiving the FEC data via a first wireless network and (ii) receiving the data via a second wireless network that is different than the first wireless network.

23. The first playback device of claim 14, wherein the program instructions that are executable by the one or more processors such that the first playback device is configured to:
after using FEC data generated according to a first FEC algorithm to correct errors in the data streamed from the second playback device, determine that the first playback device has failed to successfully receive more than a threshold amount of the data even after using the FEC data generated according to the first FEC algorithm to correct errors in the data; and
after determining that the first playback device has failed to successfully receive more than the threshold amount of the data even after using the FEC data generated according to the first FEC algorithm to correct errors in the data, start using FEC data generated according to a second FEC algorithm streamed from the second playback device to correct errors in the data, wherein the second FEC algorithm is a stronger FEC algorithm than the first FEC algorithm.
